(19) United States
(12) Patent Application Publication
(10) Pub. No.: US 2008/0072870 A1
(43) Pub. Date: Mar. 27, 2008

(54) METHODS AND SYSTEMS EMPLOYING OSCILLATING VANE MACHINES

(76) Inventors: Stephen M. CHOMYSZAK, Attleboro, MA (US); Eric D. INGERSOLL, Cambridge, MA (US)

Correspondence Address: ELMORE PATENT LAW GROUP, PC, 209 MAIN STREET, N. CHELMSFORD, MA, 01863, US

(21) Appl. No.: 11/858,963

(22) Filed: Sep. 21, 2007

Related U.S. Application Data
(60) Provisional application No. 60/846,543, filed on Sep. 22, 2006.
(60) Provisional application No. 60/889,315, filed on Feb. 12, 2007.
(60) Provisional application No. 60/910,040, filed on Apr. 4, 2007.

(51) Int. Cl. F02B 53/04

(52) U.S. Cl. 123/231

(57) ABSTRACT

The present invention is directed to an oscillating vane machine where the vanes can be operated at high speed with a minimum of vibration and with minimum mechanical loads accomplished with sinusoidal motion of the vanes utilizing an improved continuously rotating input/output which is naturally balanced.

### RELATED APPLICATIONS

This application claims priority to U.S. Provisional Application No. 60/910,040 filed on Apr. 4, 2007, U.S. Provisional Application No. 60/889,315 filed on Feb. 12, 2007 and U.S. Provisional Application No. 60/846,543 filed on Sep. 22, 2006. The entire teachings of the above application(s) are incorporated herein by reference.

### BACKGROUND OF THE INVENTION

This invention generally pertains to oscillating vane machines, which have the potential to produce high flow and high pressures from small and inexpensive packages if the oscillating vanes can be operated at sufficient speeds with a minimum of vibration and if the fluid flow of the machine can be arranged to support such high flow rates. More specifically, the present invention relates to a machine which can be adapted for use either as a compressor or as an expander comprising improvements in the methods of vane and valve actuation which allow oscillating vane machines to operate at higher speeds with reduced vibration and provide significant increases in flow rate.

Oscillating vane machines have been described in the art. U.S. Pat. No. 2,257,884, issued Oct. 7, 1941 to Mize; U.S. Pat. No. 2,393,204, issued Jan. 15, 1946 to Taylor; U.S. Pat. No. 4,099,448, issued Jul. 11, 1978 to Young; U.S. Pat. No. 4,823,743, issued Apr. 25, 1989 to Ansdale; U.S. Pat. No. 5,228,414, issued Jul. 20, 1993 to Crawford and U.S. Pat. No. 4,080,114, issued Mar. 21, 1978 to Moriarty; the contents of which are incorporated herein by reference in their entirety.

Oscillating vane machines have the potential to provide extremely high flow rates and pressures but, in order to do so, they require vane actuation and valving suitable for high speed operation. The prior art teaches against these requirements by disclosing methods which limit the machine's potential due to vibration resulting from poor vane actuation and/or fluid starvation due to insufficient port area and valve control.

The machine of Mize places a plurality of oscillating vanes in a common main chamber and relies on the ability of the vanes to seal against each other at their pivots to prevent high pressure fluid from leaking to low pressure areas. This type of seal is, at best, a line contact and is insufficient for high pressures. In Mize, the oscillating vanes are actuated via a continuously rotating crankshaft like, as known to those skilled in the art, those used in reciprocating piston machines. The fluid enters and exits the chambers through fixed, radially positioned ports which are covered and uncovered by the distal ends of the vanes as they oscillate. The fluid path of this machine is very much like that of two-stroke reciprocating piston engines where an incoming charge of fresh air is used to expel a previously combusted charge of exhaust gas. As such, the porting arrangement of Mize does not allow the oscillating vanes to provide an efficient inlet process by themselves; therefore, Mize utilizes an integrated centrifugal blower to charge the chambers with fresh air. Mize's preferred embodiment utilizes 4 oscillating vanes driven via a crankshaft with an individual crank throw for each of the 4 vanes.

Taylor discloses an oscillating vane machine used as a hydraulic motor whereby a single vane is contained within a single main chamber thereby making it more practical to seal the vane and its pivot. This type of arrangement is better suited for higher pressures; however, the actuation of a single oscillating vane at high speed will produce excessive vibration unless a counterbalance is used.

Young discloses a two-vane machine driven via a gear set and over-running clutches on the shaft of each vane. Over-running clutches do not provide reliable synchronized motion as is required by oscillating vane machines at high speed. In one embodiment a pair of rotary valves is disclosed to control the flow of fluid into and out of the machine. In yet another embodiment, Young utilizes a complicated series of rotary valves in conjunction with poppet valves. Every time a fluid passes through a valve, it loses energy and represents a source of inefficiency. In this embodiment, the fluid must pass through no less than five valves per circuit representing a highly inefficient fluid path. Poppet valves, however, have the advantage of being able to seal by pressure loading without generating friction.

Ansdale discloses a single vane machine whereby the vane is driven via a crankshaft with a separate counterbalance to reduce vibration. In one embodiment, Ansdale uses pressure activated reed valves. In another embodiment is disclosed a cam and spring actuated poppet valves with timed opening and closing, and in a third embodiment, rotary valves are used with timed opening and closing. Ansdale begins to address the balance issues but the machine will have difficulties achieving high flow rates due to the very limited passage sizes allowed for fluid flow.

Moriarty discloses a machine whereby two diametrically opposed vanes are attached to a single pivot. He calls this assembly a piston assembly and shows one embodiment, which utilizes one piston assembly, and another embodiment which utilizes two piston assemblies. He also discloses improvements on a nutating drive mechanism with a continuously rotating input/output shaft, used to actuate the oscillating piston assemblies. Moriarty also discloses a novel flow path for the fluid entering the piston chambers through the vane pivots and then through the vanes themselves with the opening and closing of the ports in the vanes being controlled with a flapper valve activated by inertia and pressure differences. He also uses various reed valves in additional embodiments for fluid inlet and discharge. As with all of the previous machines, Moriarty does not provide a fluid path which will support high flow rates while keeping the machine small.

An oscillating vane machine designed to maximize its potential will preferably utilize pairs of counter-rotating vanes which will self balance the oscillating vane masses in conjunction with a drive arrangement which is compact, self-balanced, and suitable for high speed operation. In addition, the machine must have an efficient fluid path with valves and ports that provide adequate areas to promote high flow rates which can be reliably operated at high speeds with a minimum of friction while containing high pressures.

It is known that optimization of ‘unloading’ and ‘capacity control’ can save improve flexibility of a compressor during operation in relation to energy savings. However, in the case where oscillating vane machines can be used as compressors, these features have been altogether ignored by the prior art.

An unloader is a device which prevents the compressor from generating pressure until it has reached operating speed. A compressor is typically ‘unloaded’ during start up in order to limit the amount of current draw from the motor. This allows the use of low cost motors with limited current capabilities. Once the compressor is up to operating speed, the unloader is deactivated and the compressor becomes ‘loaded’ and then begins to generate pressure.

Capacity control is utilized to vary the flow rate of a compressor while the compressor runs at a continuous speed. In cases where a compressor is used in applications with variable flow requirements, capacity control helps to reduce the power consumption of the compressor during low flow situations but allows the compressor to deliver enough fluid during high flow situations. Although capacity control can be accomplished using a variable speed motor, the variable speed drives necessary to control the motor are currently very expensive and therefore a less expensive mechanical form of capacity control is desirable.

Abbreviations

OVM, oscillating vane machine; OVMC, oscillating vane machine compressor; OVME, oscillating vane machine expander; EMP, Energy Management Program; LSE, load serving entities; CAES, compressed air energy storage

### SUMMARY OF THE INVENTION

Accordingly, it is an object of this invention to provide a new and improved oscillating vane machine which can be used as a compressor or expander.

Specifically, it is an object of the present invention to provide an oscillating vane machine where the vanes can be operated at high speed with a minimum of vibration and with minimum mechanical loads accomplished with sinusoidal motion of the vanes utilizing an improved continuously rotating cam mechanism which is naturally balanced.

Another object of the invention is to provide an oscillating vane machine with improved port area and valve actuation and control.

Another object of the invention is to provide a fluid path into and out of the machine that is easily scalable and provides sufficient flow areas in order to reduce pumping losses.

Another object of the invention is to provide a compressor with load/unload features.

Another object of the invention is to provide a compressor with capacity control features.

Another object of the invention is to provide a multi-staged compressor or expander.

In accordance with the present invention is provided an oscillating vane machine comprising: (a) a plurality of pivoted vanes each comprising (i) a vane, said vane being defined by a first side vane surface, a second side vane surface, a distal vane surface, a first lateral vane surface and a second lateral vane surface, wherein said distal vane surface defines a distal vane surface path and said first and second lateral vane surfaces define first and second lateral vane surface paths when the vane is rotated about a pivot axis, and (ii) a pivot comprising said pivot axis, (b) a plurality of individual main chambers each defined by (i) a distal chamber surface which is defined by said distal vane surface path, (ii) a first end wall chamber surface, (iii) a second end wall chamber surface, (iv) a first lateral chamber surface defined by said first lateral vane surface path and extending from the radius of the vane pivot to the distal chamber surface, and (v) a second lateral chamber surface defined by said second lateral vane surface path and extending from the radius of the vane pivot to the distal chamber surface, (c) a driver which drives all pivoted vanes in a balanced and oscillating motion; (d) at least one inlet port in fluid communication with each individual main chamber; and (e) at least one discharge port in fluid communication with each individual main chamber.

The oscillating vane machine may further comprise a housing or stator. In one embodiment, the pivots of the pivoted vanes form a conformal seal with the housing or stator. The art of sealing parts such as those of the present invention is known to those skilled in the art.

Further, the housing or stator may be coincident with one or more surfaces of said plurality of individual main chambers.

In one embodiment, the distal vane surface of each pivoted vane forms a seal with the distal chamber surface of each individual main chamber in which it is located. The surfaces forming the plurality of individual main chambers may have a coefficient of friction less than 0.5.

In a preferred embodiment, the oscillating vane machine of the invention has four individual main chambers and has one pivoted vane disposed in each chamber. The pivoted vanes may be fixed equidistant from one another.

In one embodiment, the pivoted vanes are rotated about their pivots at a 45, 60 or 90 degree angle. Furthermore, the pivoted vanes may also be double-acting.

In one embodiment, the first and second lateral chamber surfaces are fixed.

In one embodiment, the inlet and discharge ports may be located in the lateral chamber surfaces, the end wall surfaces, or the distal surface of the individual main chambers.

In one embodiment the driver of the oscillating vane machine of the invention is selected from the group consisting of a rack and pinion system, a cam and camshaft, a rod and crankshaft, a desmodromic drive system, a cam with one or more springs, a cam and rod, reciprocating gears attached to the pivots, a dual cam with pins, a dual cam with gears, a tangential torquing device, and any combination thereof. The driving mechanisms may also be balanced using a counterbalance.

The inlet and discharge ports of the invention may be valves and in certain embodiments these valves are in fluid communication with the atmosphere. The valves may also be extensible with the oscillating vane machine.

In one embodiment, the valves may be any of stationary, rotary, hinged, poppet or an array of poppet either linear or otherwise, reed (or high frequency valve), flapper and any combination thereof.

In one embodiment, the valves are actuated mechanically. In another embodiment actuation to open the valves is achieved as a result of differential pressure across the valves and actuation to close the valves is achieved mechanically.

In one embodiment the oscillating vane machine may further comprise one or more unloaders, capacity control devices, or intercoolers. The capacity control device may be selected from the group consisting of a valve, a bypass circuit, a throttle plate and any combination thereof. The cooling systems may use water as a coolant.

In one embodiment the oscillating vane machine of the invention acts as a compressor.

In one embodiment, the inlet of fluid into the inlet port is timed such that the machine operates as an expander.

The main chambers of the oscillating vane machine of the invention may be multi-staged and multi-staging may occur in 2 or more stages. Further, multiple machines may also act in concert to effect multistage compression or expansion.

### BRIEF DESCRIPTION OF THE DRAWINGS

The foregoing and other objects, features and advantages of the invention will be apparent from the following more particular description of the embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a view of a pivoted vane—PRIOR ART.

FIG. 2 is a view of a chamber in which a pivoted vane oscillates. —PRIOR ART.

FIG. 3A is a view of a machine with a single pivoted vane. —PRIOR ART.

FIG. 3B is a view of a machine with two dual-vaned pivots—PRIOR ART.

FIG. 3C is a view of the oscillating vane machine of the present invention with four main chambers each comprising one pivoted vane.

FIG. 4A is a graph of the preferred sinusoidal acceleration and deceleration profiles of an oscillating pivoted vane.

FIG. 4B is a graph of the sinusoidal acceleration and deceleration profiles of an oscillating pivoted vane when driven via a crankshaft.

FIG. 5A is a view of another embodiment of the oscillating vane machine of the present invention illustrating the actuation face of a machine with four main chambers each comprising a pivoted vane with each of the four pivoted vanes being driven via a reciprocating rack and pinion in which the racks are actuated via a symmetrical cam where one revolution of the cam produces two complete sinusoidal oscillations of each of the four pivoted vanes. The cam is labeled with a reference mark to illustrate the concerted movement of and within the machine.

FIG. 5B is a view of the embodiment of FIG. 5A having the cam removed for visual clarity.

FIG. 5C is a sequence of views of the embodiment of FIG. 5A illustrating the concerted movement of and within the machine upon rotation of the cam. The cam is labeled with a reference mark to illustrate the concerted movement of and within the machine.

FIG. 6A is a view of another embodiment of the oscillating vane machine of the present invention showing the actuation face of the machine where a reciprocating structure with two geared racks is driven via a conventional crankshaft and connecting rod. Each of the two racks is geared to an extended pinion gear whereby each extended pinion is directly connected to a vane pivot and where each extended pinion provides rotary input to a respective shorter pinion so that each revolution of the crankshaft produces one complete rotary oscillation of each of the four vanes via the reciprocating motion of the rack structure.

FIG. 6B is and elevation view of the machine of FIG. 6A.

FIG. 7A is a view of another embodiment of the oscillating vane machine of the present invention showing the actuation face of the machine with four pivoted vanes with each of the four pivots being driven via a synchronous belt and pulley in which the belts are actuated via four reciprocating drive members which in turn are actuated via a symmetrical cam where one revolution of the cam produces two complete sinusoidal oscillations of each of the four vanes. The cam is not shown but is identical to the cam used in FIG. 5A.

FIG. 7B is an end view of the machine of FIG. 7A.

FIG. 8 is a view of another embodiment of the oscillating vane machine of the present invention showing the actuation face of the machine. This embodiment shows a single-acting actuated oscillating vane machine of the present invention having four pivoted vanes with a grooved cam which actuates a pin connected to a pinion whereby one revolution of the cam produces one complete sinusoidal oscillation of each of the four pivoted vanes.

FIG. 9 is a view of another embodiment of the oscillating vane machine of the present invention showing the actuation face of the machine. This embodiment shows a double-acting actuated oscillating vane machine of the present invention having four pivoted vanes with a cam which actuates four pins each connected to a pinion whereby one revolution of the cam produces two complete sinusoindal oscillations of each of the four vanes.

FIG. 10 is a view of another embodiment of the oscillating vane machine of the present invention showing the actuation face of the machine. This embodiment shows a triple-acting actuated oscillating vane machine of the present invention having four pivoted vanes with a grooved cam which actuates a pin connected to a pinion whereby one revolution of the cam produces three complete sinusoidal oscillations of each of the four pivoted vanes.

FIG. 11 is a view of another embodiment of the oscillating vane machine of the present invention showing the actuation face of the machine. This embodiment shows a quadruple-acting actuated oscillating vane machine of the present invention having four pivoted vanes with a dual cam which actuates four pins connected in pairs to each of two pinions whereby one revolution of the cam produces four complete sinusoindal oscillations of each of the four vanes. The dual cam is shown as being transparent.

FIG. 12 is a view of a dual cam useful as a driver of the oscillating vane machine of FIG. 11.

FIG. 13 is a view of the oscillating vane machine showing the actuation face of the machine of FIG. 11, with the dual cam removed to illustrate the location of the two pairs of pins whereby each pair consists of a short and long pin.

FIG. 14A is a view of another embodiment of the oscillating vane of the present invention showing the actuation face of the machine. This embodiment shows a single-acting machine with reciprocating plate as an actuation mechanism.

FIG. 14B is a view of the embodiment of FIG. 14A having the reciprocating plate removed for visual clarity.

FIG. 15A is a view of an axial face (here a porting face) of the oscillating vane machine of the present invention illustrating the inlet ports and valves.

FIG. 15B illustrates the beginning of a cycle of fluid flow into the machine and the actuation of the valves.

FIG. 16 is a view of one unit of an inlet valve assembly.

FIG. 17 is a view of multiple inlet valve and discharge valve assemblies of an oscillating vane machine of the present invention.

FIG. 18A is a view of an axial face (here a porting face) of the oscillating vane machine of the present invention illustrating the discharge ports and valves.

FIG. 18B is an end view of FIG. 18A showing the arrangement of the discharge valves.

FIG. 19 is a view of one unit of a discharge valve assembly of the present invention.

FIG. 20A is a view of an embodiment of the machine showing the inlet face of the machine and the radially oriented inlet ports arranged around the outer periphery of the machine.

FIG. 20B is a view of an embodiment of an extended machine showing the inlet face of the machine and the extended radially oriented inlet ports arranged around the outer periphery of the machine.

FIG. 20C is a view of the machine in FIG. 20A showing the discharge face of the machine and the radially oriented discharge ports arranged around the outer periphery of the machine.

FIG. 20D is a view of the extended machine of FIG. 20C showing the discharge face of the machine and the extended radially oriented discharge ports arranged around the outer periphery of the machine.

FIG. 21A is a view of an embodiment of the machine showing the inlet face of the machine and the axially oriented inlet ports arranged on the inlet face of the machine.

FIG. 21B is a view of the machine of FIG. 21A showing the discharge face of the machine and the axially oriented discharge ports arranged on the discharge face of the machine.

FIG. 22 is a view of one embodiment of the oscillating vane machine of the present invention illustrating a dwell-containing cam.

FIG. 23 is a graph of the preferred sinusoidal acceleration and deceleration profiles of an oscillating pivoted vane configured in the oscillating vane machine of the present invention having a dwell-containing cam.

### DETAILED DESCRIPTION OF THE INVENTION

A description of the preferred embodiments of the invention follows. Referring now to the drawings wherein the views are for purposes of illustrating preferred and alternate embodiments of the invention only and not for purposes of limiting same. While the oscillating vane machine is designed for and will hereinafter be described as either a compressor or an expander, it will be appreciated that the overall inventive concept involved could be adapted for use in many other machine environments as well, such as engines and pumps.

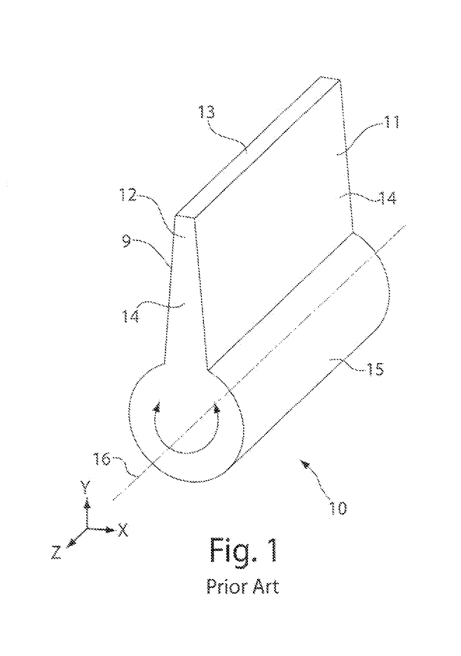

Reference is now made to the figures. FIG. 1 shows an embodiment in the prior art of a single pivoted vane 10 which is comprised of a vane 9 and a vane pivot 15. The vane further comprises a first side vane surface 11, a second side vane surface 12, a distal vane surface 13 and a pair of (a first and a second) lateral vane surfaces 14. The pivoted vane rotates or oscillates about a pivot axis 16. It is understood that because the vane oscillates or pivots within the chamber that the first and second side vane surfaces may be referred to “leading” and “trailing” surfaces. These terms are relative to the direction the pivoted vane is moving and therefore the naming of side vane surfaces 11 and 12 are interchangeable when discussing the direction the pivoted vane is moving.

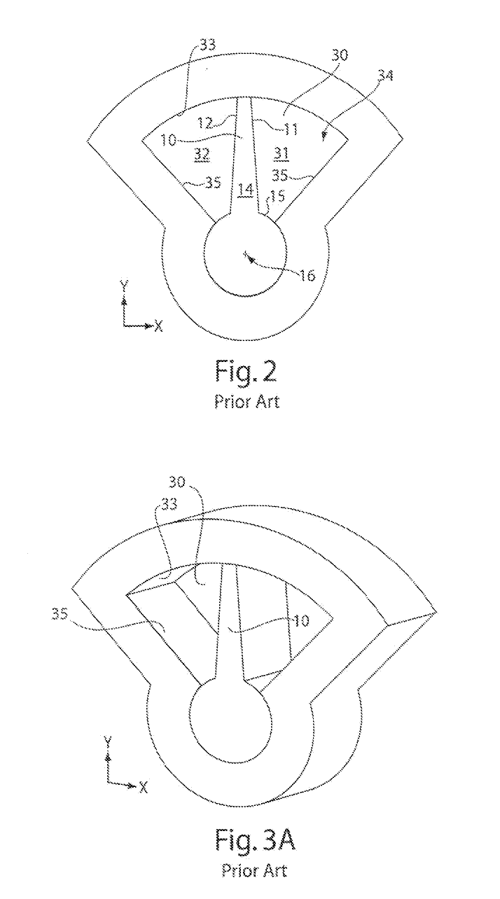

FIG. 2 shows a pivoted vane 10 within a single main chamber 30. The open space of the main chamber when occupied by a pivoted vane is defined by a leading chamber 31, a trailing chamber 32. It is understood that because the vane oscillates or pivots within the chamber that “leading” and “trailing” are relative to the direction the pivoted vane is moving and therefore the labeling of chambers 31 and 32 are interchangeable depending on the direction of the pivoted vane. The chamber is further defined by a distal chamber surface 33 defined by said distal vane surface 13 path, two (a first and a second) end wall chamber surfaces 35 and two (a first and a second) lateral chamber surfaces 34 defined by said lateral vane surface 14 paths extending from the radius of the vane pivot 15 to the distal chamber surface 33. In the figure view, the plane of the drawing defines one of the lateral chamber surfaces 34. The distal vane surface 13 defines a distal vane surface path and the pair of lateral vane surfaces 14 define a pair of lateral vane surface paths when each vane is rotationally oscillated about its axis of rotation 16.

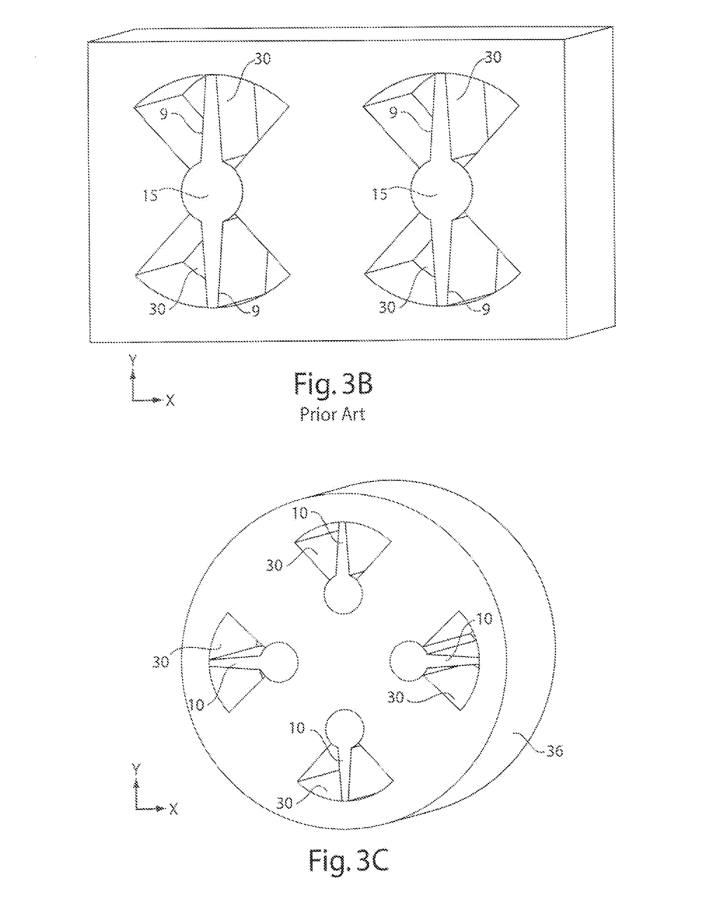

FIG. 3A shows a single pivoted vane 10 operating in a single main chamber 30.

FIG. 3B shows two dual-vaned pivots of the prior art operating in four individual chambers.

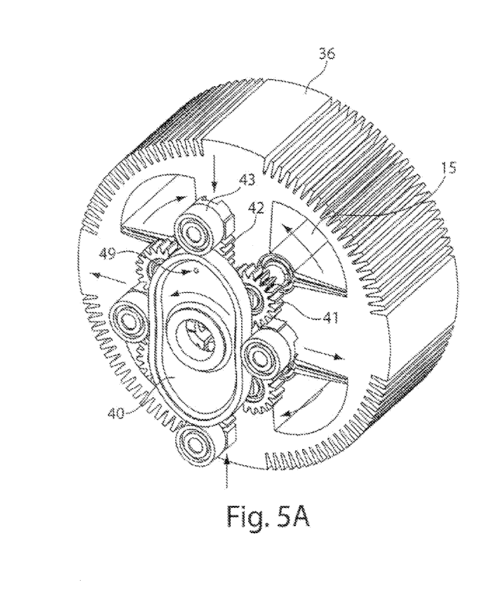

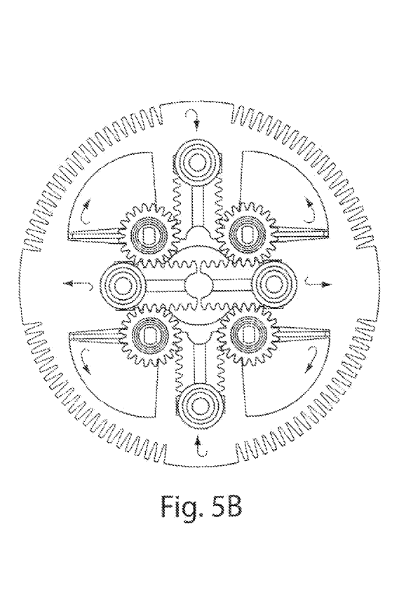

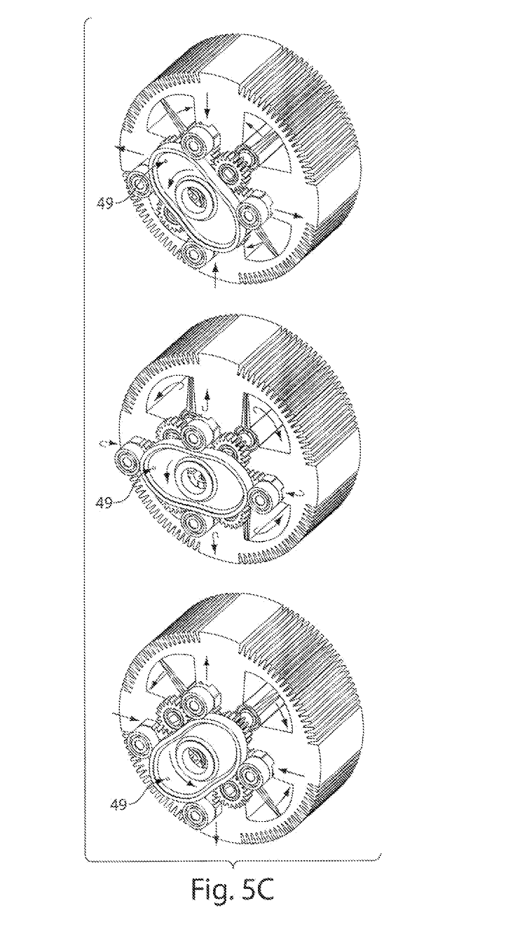

FIG. 3C shows the oscillating vane machine of the present invention having four individual pivoted vanes 10 operating in four individual main chambers 30. In accordance with the present invention, the number of individual main chambers is preferably 4; however, more or less chambers can be utilized such as 2 or 6 or 8. The main chambers 30 are contained within a stator 36. The stator may be smooth, or it may be machined to accommodate the application. In one embodiment the stator is machined to have fins or fin projections. (See FIGS. 5-21). The oscillating vane machine of the present invention may further be contained within a housing (not shown). According to the present invention, the stator and/or the housing may be coincident with or form one or more surfaces of the plurality of chambers.

The pivoted vanes 10 of the oscillating vane machine of the present invention can be chosen, selected or manufactured from a wide array of materials and can be dependent on application or the intended use of the machine. For example, at low pressure and low temperature, the pivoted vanes may be manufactured from a plastic or plastic-like material. At high pressure and temperature, it may be desired to have pivoted vanes manufactured from a stronger material such as a metal or ceramic. Therefore, according to the present invention, the pivoted vanes may be manufactured from steel, aluminum, or any metal, plastic, ceramic, composite, polymer or the like. Furthermore, it may be advantageous to plate or overmold the pivoted vanes with a layer, film or deposit of a second material. The plating or overmolding may comprise the same material as the pivoted vane substrate or may be different in kind or amount. For example, a metal pivoted vane may be plated or overmolded with a polymer or plastic to improve movement within the main chamber by reducing friction. Overmolding and plating of the pivoted vanes may be complete or only to select pivoted vane surfaces or edges or to only the pivot.

The pivoted vanes of the oscillating vane machine of the present invention may also be designed to undergo or withstand a certain degree of deformity. Generally, larger machines, (e.g., larger pivoted vanes), can withstand more deformity. It is understood in the art that one problem with oscillating vanes is detrimental harmonics. It is therefore desired to design the vanes of the present invention and the vane actuation system to avoid any detrimental harmonic events. This problem is addressed in the selection of materials, size and proportion of pivoted vanes as well as the acceleration and deceleration profiles of the oscillating motion of the pivoted vanes so that the magnitude of the pivoted vane resonance will be minimized and occur at a frequency higher than the frequency at which the pivoted vanes will be operated thereby avoiding a detrimental harmonic contribution from the pivoted vane or actuation system.

In one embodiment of the invention, the distal surface of one or more of the plurality of pivoted vanes lying parallel to the axis of the pivot is a surface which is substantially flat, convex, concave, toroidal, slanted or any nonflat shape specifiable by a mathematical equation.

In another embodiment of the invention, the lateral surfaces or side surfaces of one or more of the plurality of pivoted vanes is substantially flat, convex, concave, toroidal, slanted or any nonflat shape specifiable by a mathematical equation.

Furthermore, the pivoted vanes of the oscillating vane machine of the present invention may be rotated about their pivots at an angle of 45, 60 or 90 degrees.

In one embodiment, the pivoted vanes of the oscillating vane machine of the present invention may be double-acting while the actuation or driving mechanism of the vanes may be single-acting, double-acting, triple-acting or quadruple-acting, and the like. In one embodiment, the pivots are fixed equidistant to one another.

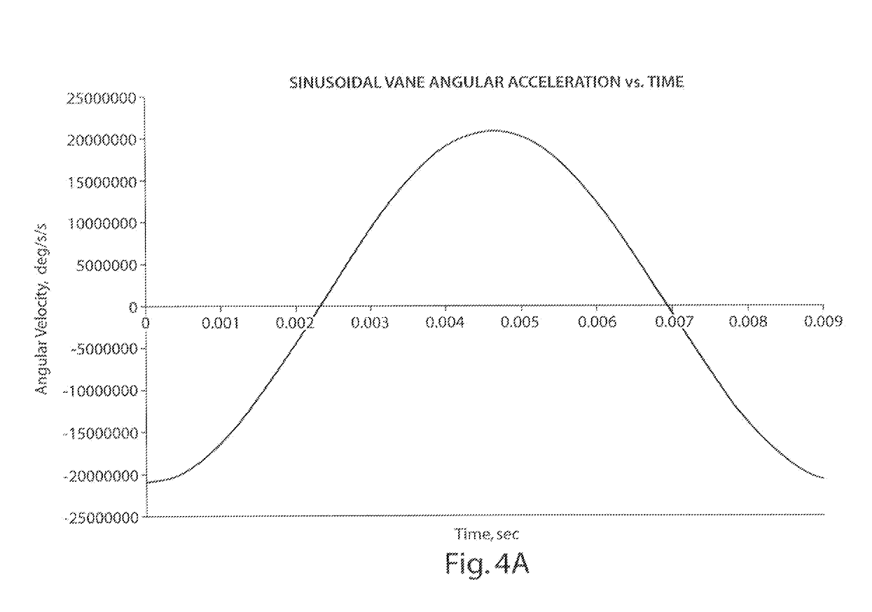

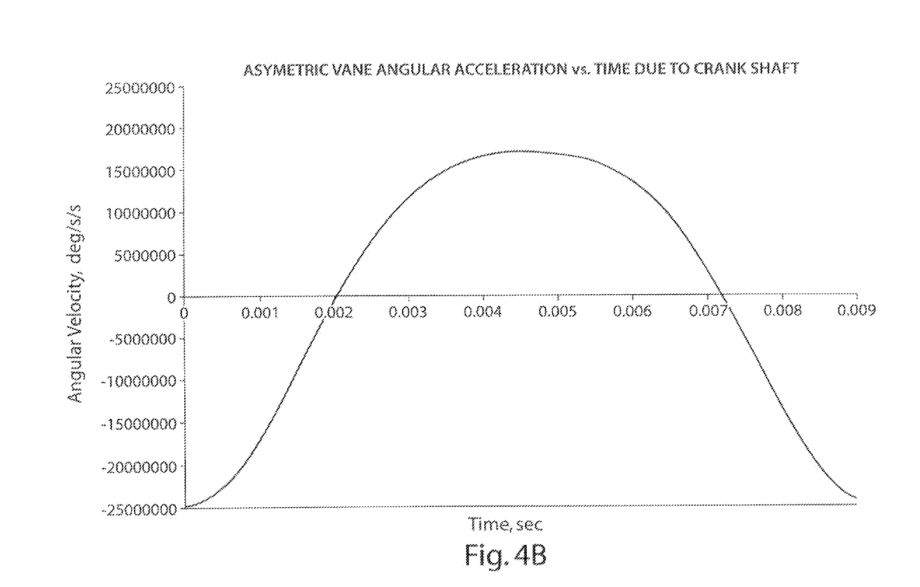

Symmetry is more important as the speed required increases. As is known in the art, the need for symmetric motion is often addressed by attempting to achieve sine curve motion. FIG. 4A shows a graph of sinusoidal acceleration and deceleration of an oscillating pivoted vane. This type of motion is well known to those skilled in the art of machine design and is preferable over other types of motion because it reduces inertial loads, which is important in high speed machines.

FIG. 4B shows a graph of the sinusoidal acceleration and deceleration of an oscillating pivoted vane when driven via a crankshaft. Notice that the graph is asymmetric meaning that the magnitude of the loads on the components are higher during one phase of the cycle than the other phase. These higher loads translate to larger inefficiencies in the mechanical system due to the addition of weight in the form of stronger components and friction due to higher loads being absorbed by the bearings which support the components. As is known to those skilled in the art, the longer the connecting rod, the more symmetric the motion becomes; however, in order to achieve the symmetry of FIG. 4A, the connecting rod would have to be infinite in length. As such, crankshaft driven systems always produce asymmetric sinusoidal motion.

Several embodiments of the present invention, unlike machines in the art, are able to produce symmetric sinusoidal motion of the oscillating vanes via novel drive mechanisms. This will allow those embodiments to operate at sufficient speeds resulting in increased flow rates from smaller machines.

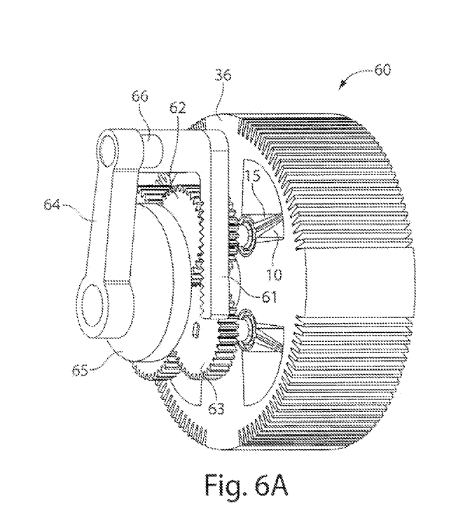

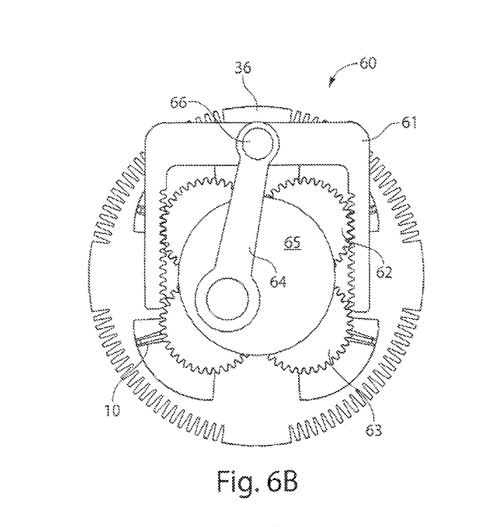

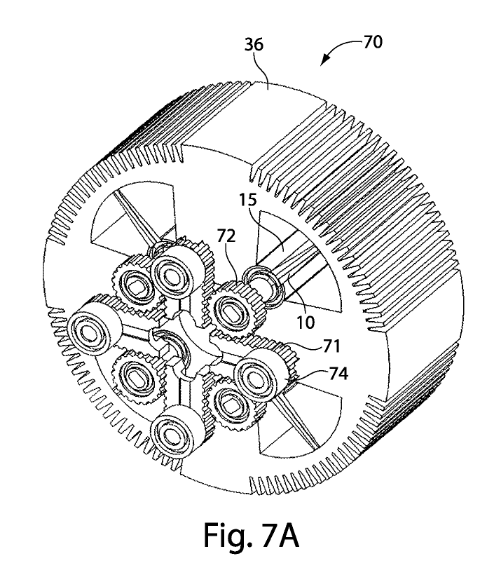

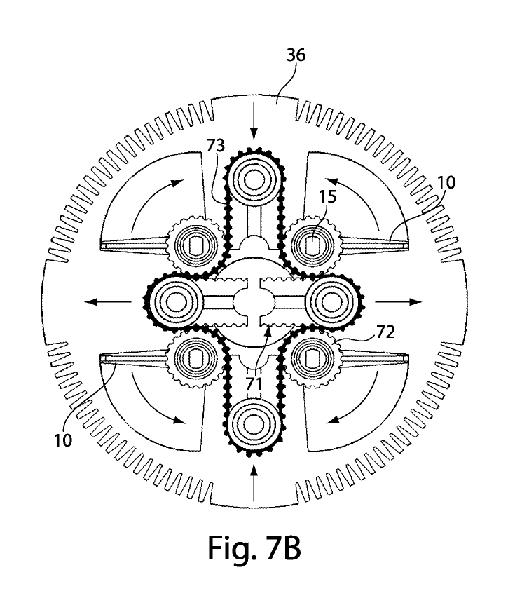

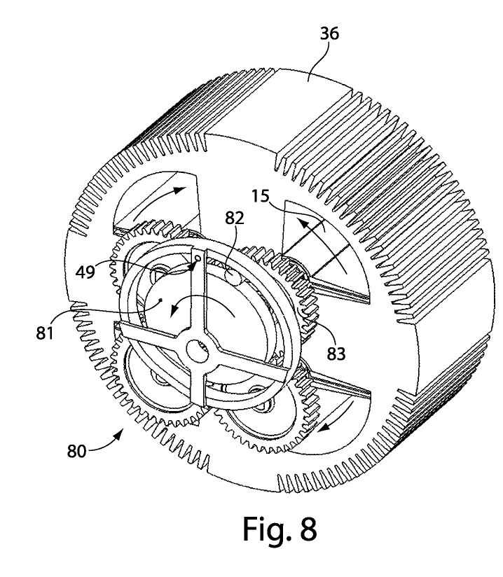

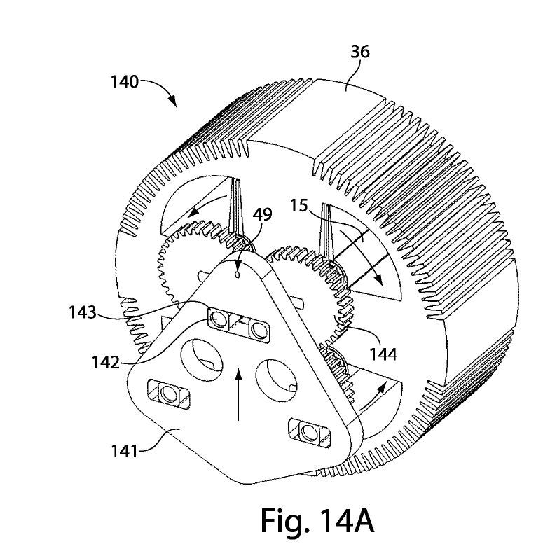

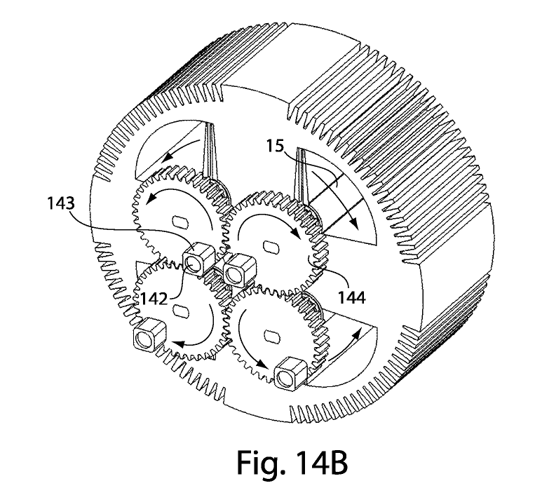

There are five categories of drive mechanisms of the present invention: Category 1 is comprised of a cam which drives a set of reciprocating racks which in turn are geared to rotary oscillating pinions which drive the vane pivots. This type of mechanism is shown in FIG. 5A-B. Category 2 is comprised of a cam, or cams, which drive pins connected to rotary oscillating pinions which drive the vane pivots without any reciprocating members. Several embodiments of this mechanism are shown in FIGS. 8 through 13. Category 3 is comprised of a conventional crankshaft and connecting rod mechanism which drive a reciprocating rack which is geared to rotary oscillating pinions which drive the vane pivots. This type of mechanism is shown in FIG. 6A-B. Category 4 is comprised of a cam which drives a set of toothed reciprocating members which convert their reciprocating motion to rotary oscillating toothed pulleys via a toothed belt. The toothed pulleys drive the vane pivots. The toothed belt does not rotate. It simply changes shape as the toothed reciprocating members move towards or away from the center of the machine. In so doing, the toothed pulleys are forced to rotate in an oscillatory manner. This type of mechanism is shown in FIGS. 7A-B. Category 5 is comprised of a conventional crankshaft and connecting rod which drive a reciprocating plate whereby pin connected to pinions are able to slide along actuation slots in the plate thereby forcing the pinions to rotate in an oscillatory fashion. The pinions are connected to the vane pivots. This type of mechanism is shown in FIG. 14A-B. The pinions can alternatively be replaced by lever arms.

It is understood by those of skill in the art that reciprocating components would require a form of linear guidance.

FIG. 5A shows an oscillating vane machine of the present invention with four pivoted vanes arranged as shown in FIG. 3C. In the figure, each of the pivoted vanes 10 is driven by a pinion 41 attached to the vane pivot 15 and actuated by a reciprocating rack 42 driven by a cam 40. It will be understood by those skilled in the art that the pinion may be replaced without undue experimentation by any driven member and that the cam driven reciprocating rack may be replaced by any suitable driving member.

Here, the cam 40 drives the reciprocating rack 42 via a roller 43 which is in rolling contact with the cam profile to reduce friction. The profile of said cam 40 is such that the driving member, here a reciprocating rack 42 imparts the desired motion to the driven member, here a pinion 41 which in turn actuates the pivoted vane 10 sinusoidally.

As the cam 40 rotates through one revolution, it imparts two complete oscillatory cycles to each of the four vanes. In the figure, the cam is labeled with a reference mark 49 to illustrate the concerted movement of and within the machine on viewing the series of figures in 5C. It is noted that if the gear arrangement disclosed by Mize (U.S. Pat. No. 2,257,884) is used, it is possible to have reciprocating racks 42 driven in opposed pairs thereby canceling out the vibrational components of each other's reciprocating masses.

FIG. 5B is a view of the embodiment of FIG. 5A having the cam removed for visual clarity. Motion arrows on the figure indicate the movement of and within the machine.

FIG. 5C is a series of views of the embodiment of FIG. 5A illustrating the concerted movement of and within the machine upon rotation of the cam. Again the reference mark has been added to the figure to aid in visualizing the motion.

FIG. 6A shows another embodiment of the oscillating vane machine of the present invention with four pivoted vanes arranged as shown in FIG. 3C.

FIG. 6A illustrates a Category 3 actuated machine 60 (Crankshaft Driven Rack). Here, reciprocating racks 61 engages two extended pinions simultaneously. In order to provide enough room for the legs of the rack to reciprocate through their full travel, the two pinions have been lengthened to create long pinions 62. The long pinions 62 are in turn geared to short pinions 63. The reciprocating racks 61 reciprocate via a connecting rod 64 and crankshaft 65. The reciprocating rack 61 is connected to the connecting rod 64 via a wrist pin 66. It will be understood by one of skill in the art that the rack may be arranged in different ways to thereby engage one, two, three or four pinions. It will also be understood by those skilled in the art that the pinions may be replaced without undue experimentation by any driven member and that the reciprocating structure comprised of two racks may be replaced by any suitable driving member.

FIG. 6B shows an elevation of the machine of FIG. 6A.

FIGS. 7A-B shows another embodiment of the oscillating vane machine 70 of the present invention with four pivoted vanes arranged as shown in FIG. 3C.

In the figure, each of the oscillating pivoted vanes 10 are driven by a reciprocating toothed pulley 71 which is actuated by a cam (not shown). This actuation is similar to the Category 1 machine. The only difference being that instead of using four pinions which are geared directly to the reciprocating racks, this machine uses a ‘synchronous’ belt. A synchronous belt is one that is toothed, typically used in applications where timing and positioning are important, which transfers the motion between the reciprocating toothed pulleys 71 and the rotating toothed pulleys 72. It is noted that the belt itself does not rotate—it simply changes shape due to the reciprocating pulleys, and as it does so, the rotating toothed pulleys rotate. FIG. 7B shows an end view of the embodiment of FIG. 7A. It shows the toothed drive belt 73 driven by a reciprocating toothed pulley 71. The cam drives the reciprocating toothed pulley via a roller 74 which is in rolling contact with the cam profile to reduce friction. The profile of the cam is such that the toothed drive belt 73 imparts the desired motion to the pulley which in turn actuates the pivoted vane 10 sinusoidally.

Taking advantage of the gear arrangement disclosed by Mize it is possible to have reciprocating members driven in opposed pairs thereby canceling out the vibrational components of each other's reciprocating masses.

It will be understood by those skilled in the art that the driven member, here a pulley and preferably a toothed pulley, may be replaced without undue experimentation by any driven member. Likewise the flexible member, here a belt, preferably a toothed belt, may be replaced without undue experimentation with another suitable flexible member.

This system has several advantages. First, the belt provides a ‘cushion’ and acts to absorb imperfections in the assembly and alignment of the system. Belt drives are also quiet and inexpensive; however, the pulley sizes must be determined according to the amount of power to be transmitted through the belt. Second, the belt ‘cradles’ roughly 25% of the rotating pulley circumference. This means that the driving load is spread out over many teeth on the belt. In comparison, a gear set usually transmits is entire power through only one or two gear teeth at any given time.

According to another embodiment of the invention, it is preferred that there be no linearly reciprocating parts involved in actuation or driving of the machine. FIGS. 8-13 illustrate variations of this category of actuation.

FIG. 8 shows an oscillating vane machine of the present invention driven by a single-acting drive mechanism. By “single-acting” it is meant that one revolution of the cam produces one complete sinusoidal oscillation of each of the four pivoted vanes.

As illustrated in FIG. 8, the single-acting Category 2 machine 80 having four pivoted vanes is driven via the motion of a cam 81 which drives a single pin 82 within a groove in the cam. The pin is operably connected to one of the pinions 83 which in turn drive the motion of the pivoted vanes via its connection to the remaining three pinions in the system, all of which are connected to the vane pivot 15 of each pivoted vane.

In FIG. 8 the cam 81 is shown as a cut-away to reveal the groove in which the pin runs. The cam in fact is a solid disc with the groove milled to allow the pin to run in the groove and to rise and fall as the cam turns.

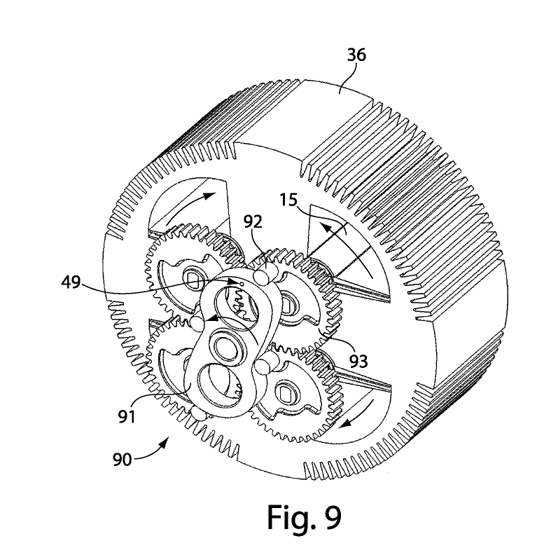

FIG. 9 shows an oscillating vane machine of the present invention driven by a double-acting drive mechanism. By “double-acting” it is meant that one revolution of the cam produces two complete sinusoidal oscillations of each of the four pivoted vanes. This embodiment is perfectly balanced and requires no additional counterweights.

As illustrated in FIG. 9, the double-acting Category 2 machine 90 having four pivoted vanes is driven via lever arms which follow the motion of a cam 91 which drives four pins 92. The pins are operably connected to the pinions 93 which in turn drive the motion of the pivoted vanes via its connection to the vane pivot 15 of each pivoted vane.

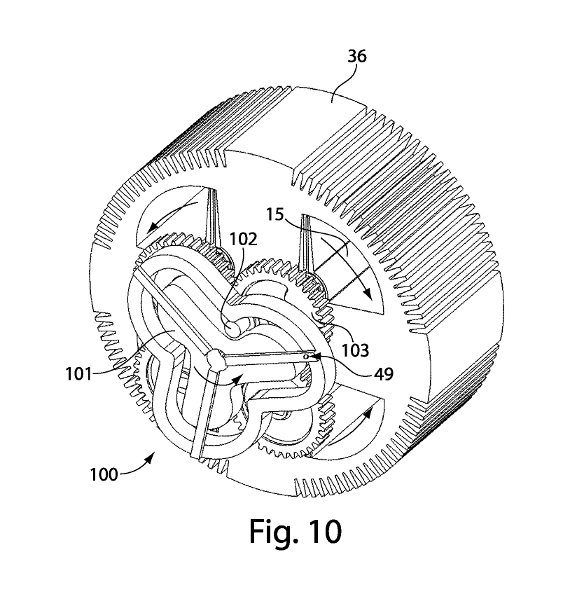

FIG. 10 shows an oscillating vane machine of the present invention driven by a triple-acting drive mechanism. By “triple-acting” it is meant that one revolution of the cam produces three complete sinusoidal oscillations of each of the four pivoted vanes.

As illustrated in FIG. 10, the triple-acting Category 2 machine 100 having four pivoted vanes is driven via the motion of a cam 101 which drives a single pin 102 within a groove in the cam. The pin is operably connected to one of the pinions 103 which in turn drive the motion of the pivoted vanes via its connection to the remaining three pinions in the system, all of which are connected to the vane pivot 15 of each pivoted vane.

In FIG. 10 the cam 101 is shown as a cut-away to reveal the groove in which the pin runs. The cam in fact is a solid disc with the groove milled to allow the pin to run in the groove and to rise and fall as the cam turns.

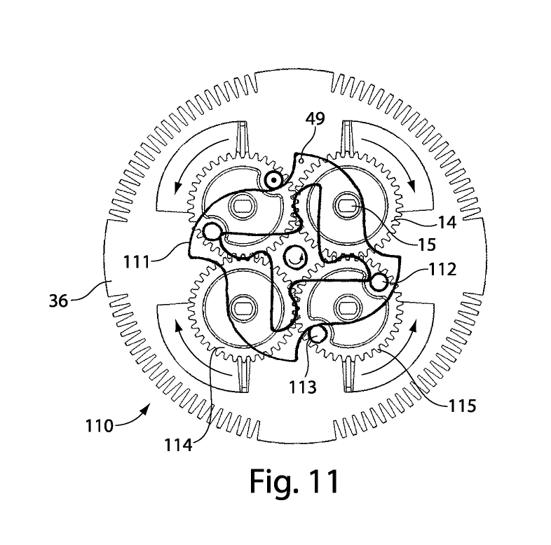

FIG. 11 shows an oscillating vane machine of the present invention driven by a quadruple-acting drive mechanism. By “quadruple-acting” it is meant that one revolution of the cam produces four complete sinusoidal oscillations of each of the four pivoted vanes. This embodiment is also perfectly balanced and requires no additional counterweights.

As illustrated in FIG. 11, the quadruple-acting Category 2 machine 110 having four pivoted vanes is driven via the motion of a dual cam 111 (drawn transparently in the figure) which drives two short pins 112 and two long pins 113. The pinions of this embodiment are characterized as pin-free pinions 114 or pin-bearing pinions 115. Pin-bearing pinions 115 in turn drive the motion of the pivoted vanes via their connection to the vane pivot 15 of each pivoted vane.

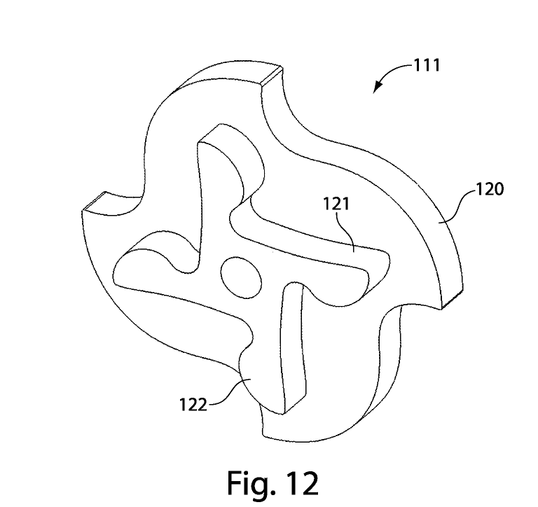

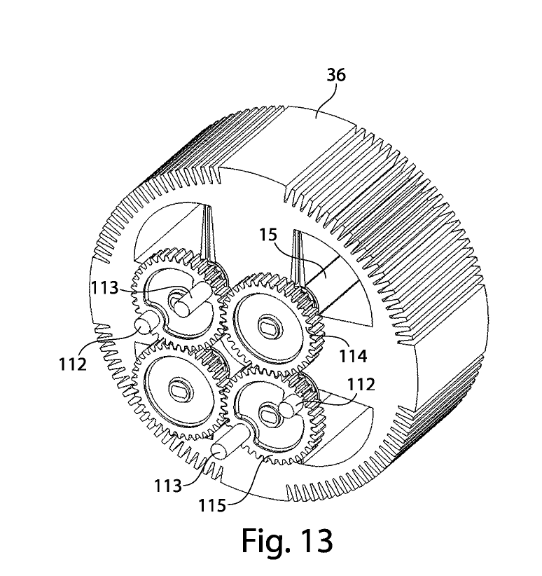

FIG. 12 shows a solid view of the dual cam 111 of FIG. 11. The cam may be manufactured or milled from a solid structure or the lobes may be manufactured separately and then attached to one another. The dual cam contains two cam contours. A first contour 120 interacts with the long pins while the second contour 121 interacts with the short pins. The bi-lobed cam 111 is seated onto the pins with the second contour 121 being the innermost facing in the machine. As such the face of the second contour represents the inner axial face 122 of the contour.

FIG. 13 is a view of the oscillating vane machine of FIG. 11, with the bi-lobed cam removed to reveal the location of the short pins 112 and long pins 113 and their interaction with the pin-free pinions 114 and the pin-bearing pinions 115.

When driving the oscillating vane machine of the present invention at an odd ratio (e.g., single-acting and triple-acting) only one pin is used and all power must be applied to this pin. However, in even driving ratios (e.g., double-acting and quadruple-acting) the power is distributed over four pins making stress on any one pin less.

FIG. 14A shows an oscillating vane machine of the present invention with four pivoted vanes arranged as shown in FIG. 3C.

As illustrated in FIG. 14A, the single-acting Category 5 machine 140 having four pivoted vanes which follow the motion of a reciprocating plate 141 with three slots which drives four pins 142. The pins are fitted with pin bushings 143 which serve to guide the round pins within the rectilinear slots in the reciprocating plate. The pins are connected to the pinions 144 which in turn drive the motion of the pivoted vanes via its connection to the vane pivot 15 of each pivoted vane. In the figure, the reciprocating plate is labeled with a reference mark 49.

FIG. 14B is a view of the embodiment of FIG. 14A having the reciprocating plate removed for visual clarity. Motion arrows on the figure indicate the movement of and within the machine. The pinions may be replaced with lever arms.

Factors which dictate the flow rate into the individual main chambers include the volume of the chamber and the speed at which the chamber is being processed. Additionally the flow through the ports dictates the maximum velocity through the ports. It is desired to keep the average gas velocity below 0.3 times the speed of sound (0.3 Mach) because at this flow, gases are treated as incompressible fluids. It is known to those skilled that minimizing gas velocity through a valve or port minimizes energy looses in the overall system; therefore, it is often endeavored to maintain average gas velocities below 0.3 mach, preferably around 0.1 mach.

Valves useful in the present invention include stationary, rotary, hinged, poppet, reed (or high frequency valve), flapper and the like. The valves of the machine may also be arrayed linearly or in preselected patterns. In order to minimize flow restrictions, valve plates may also be used. These plates allow the chamber pressure to be the determinant factor in valve opening.

The valves of the present invention hinge away from the ports opening in response to pressure differentials and are closed mechanically. They remain closed due to an opposite pressure differential and are able to effect a tighter seal as the pressure differential increases, similar to a poppet valve. This aspect of the invention (i.e., opening the inlet and discharge ports via variable pressure and closing them mechanically) is novel in that it creates a variable pressure ratio valving system. The mechanical closure of the valves may also be timed. This actuation of the valves (i.e., opening and closing) scheme eliminates backflow on inlet as well as discharge from the chamber. In one embodiment, when the machine of the invention operates as an expander, both opening and closing of the valves is timed.

In the present invention, it is preferable that the discharge valve close at the point the pivoted vane reaches the end of its oscillation path. This keeps the pivoted vane from pulling any liquid or gas back out through the discharge port.

Actuators, or devices that operate to open and/or close a valve, may be selected based on the desired operational speed of the machine. Parameters that must be considered include the speed of actuation desired and how much actuation is necessary for a particular valve. For example, in normal engines, the amount of movement of any valve can be problematic due to the mass of the valve, resulting in “valve float.” Valve float occurs, when the speed of the engine is too great for the valve springs to control the valve, and hence the valves will stay open and/or “bounce” on their seats. Reducing the mass of the valves can reduce valve float.

Inlet porting in the oscillating vane machine of the present invention is achieved when fluid or gas (e.g., air) enters the machine via the main inlet port. The gas stream is then split into four pillars, each of which bifurcate into two ports, one to each of two adjacent main chambers.

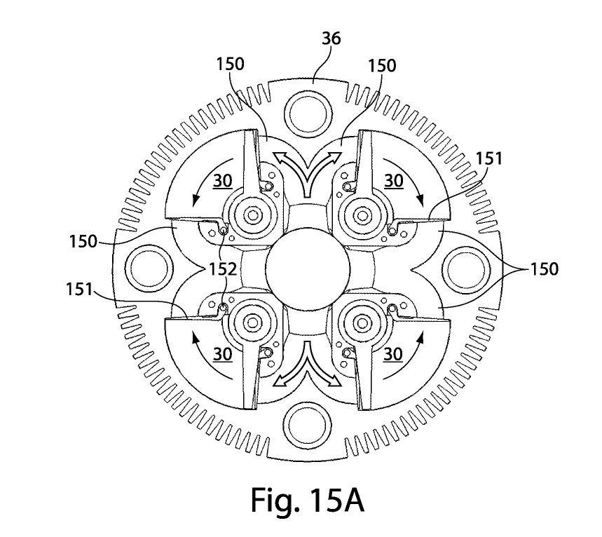

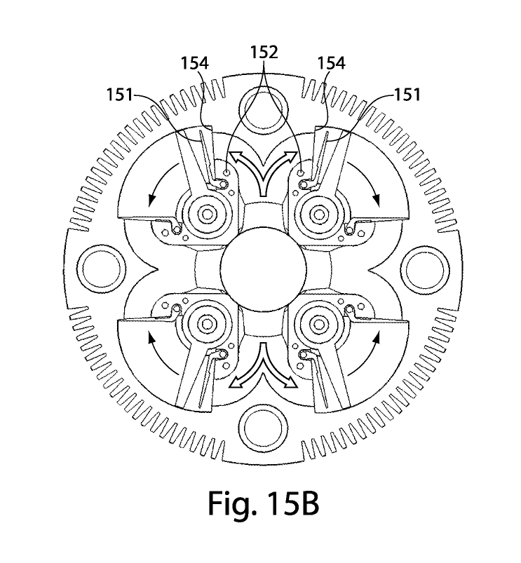

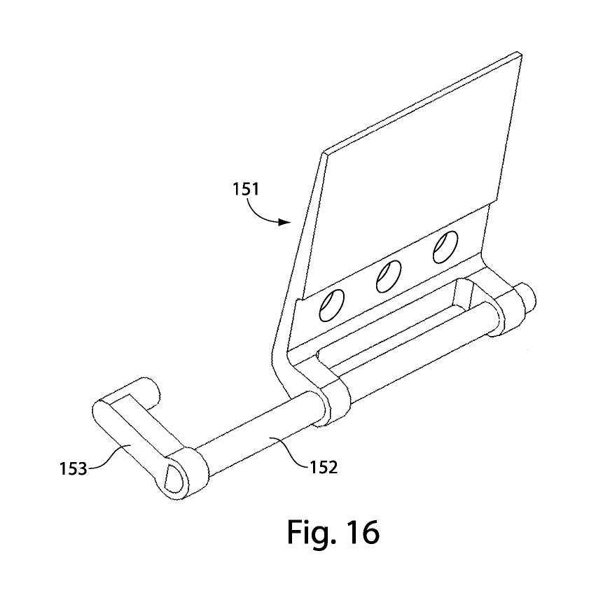

FIGS. 15A and B shows the porting face of the oscillating vane machine of the present invention with four pivoted vanes operating in four individual main chambers where each main chamber has at least one bifurcated inlet port 150 in fluid communication with each of said main chambers 30 where the flow of fluid through the inlet port is controlled by an inlet valve 151 mounted on a valve shaft 152 to which is connected an actuation arm 153 (shown in FIG. 16) where the actuation arm is activated via a cam or similar apparatus attached to the vane pivot 15. FIG. 15B shows the relative arrangement of the inlet valve 151 and the valve seat 154. The inlet valve 151 seals against a valve seat 154 which is the area around the port which the valve overlaps to effectuate the seal.

FIGS. 15A-B have been labeled with directional arrows to indicate fluid flow in the machine and to illustrate the actuation of the inlet valves.

FIG. 16 shows one unit of an inlet valve assembly of the present invention. The inlet valve 151 is mounted on a valve shaft 152 to which is connected an actuation arm 153. The actuation arm is then activated via a cam or similar apparatus.

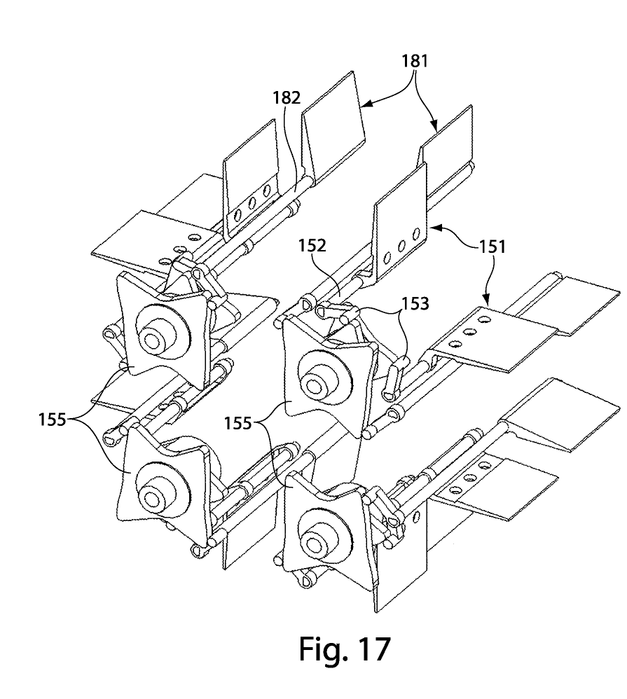

FIG. 17 shows an inlet valve and discharge valve assembly of the present invention. The inlet valves 151 are seen mounted on the valve shafts 152 to which is connected an actuation arms 153. The actuation arm is then activated via a cam 155 or similar apparatus.

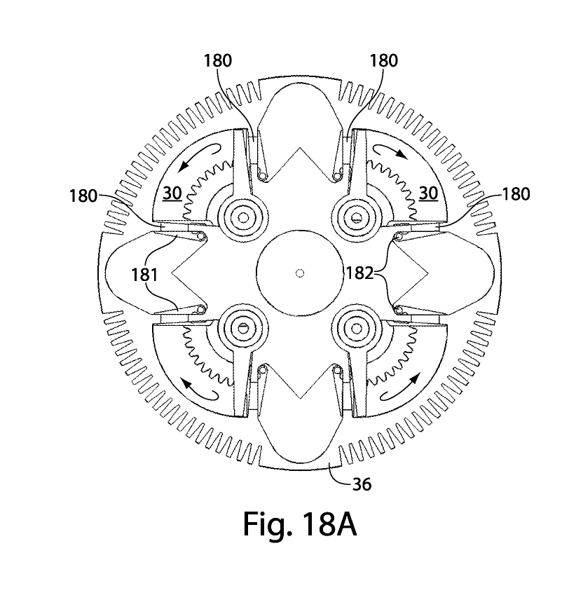

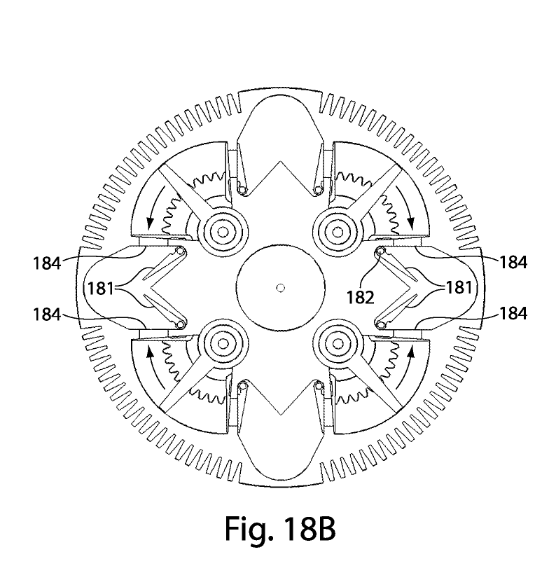

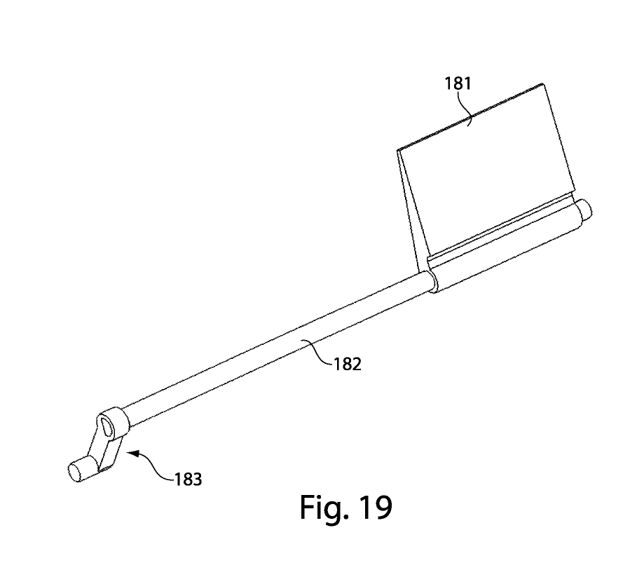

FIG. 18A shows the porting face of the oscillating vane machine of the present invention with four pivoted vanes operating in four individual main chambers where each main chamber has at least one bifurcated discharge port 180 in fluid communication with each of said main chambers 30 where the flow of fluid through the discharge port is controlled by a discharge valve 181 mounted on a discharge valve shaft 182 to which is connected a discharge actuation arm 183 (shown in FIG. 19) where the actuation arm is activated via a cam or similar apparatus attached to the vane pivot 15.

FIG. 18B shows the relative arrangement of the discharge valves 181 and the valve seat 184. The discharge valve 181 seals against a valve seat 184 which is the area around the discharge port which the valve overlaps to effectuate the seal.

FIGS. 18A-B have been labeled with directional arrows to indicate a cycle of fluid flow in the machine and to illustrate the actuation of the discharge valves. For fluid discharge, the path of flow is perpendicular to the plane of the view. One of skill in the art will understand that to indicate this flow, the path would rise out from the plane of the page at the reader from the pillars located at 3 and 9 o'clock.

FIG. 19 shows a discharge valve assembly of the present invention. The discharge valve 181 is mounted on a valve shaft 182 to which is connected an actuation arm 183. The actuation arm is then activated via a cam or similar apparatus as described herein.

The oscillating vane machine can be ported in any number of ways. Unlike any machine in the art, porting of the oscillating vane machine of the present invention is extensible with the machine. This is referred to herein as radial porting. More specifically, the ports of the oscillating vane machine of the present invention may extend axially as the machine extends axially. Consequently as the machine increases in size, the port area increases proportionally and is always in a condition of maximal fluid exchange. Hence, the present design allows extensible porting.

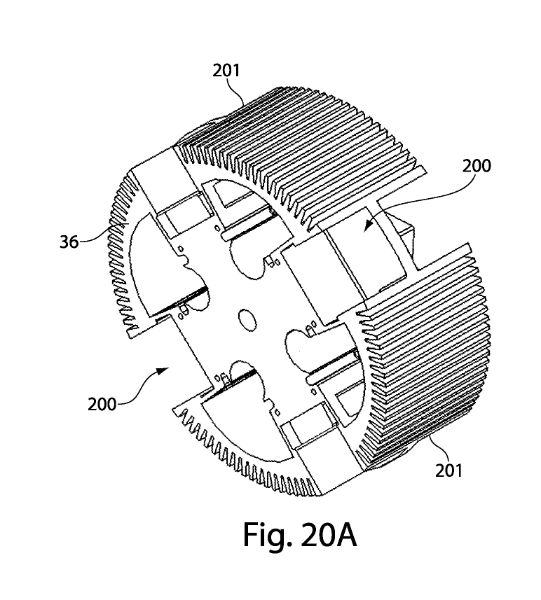

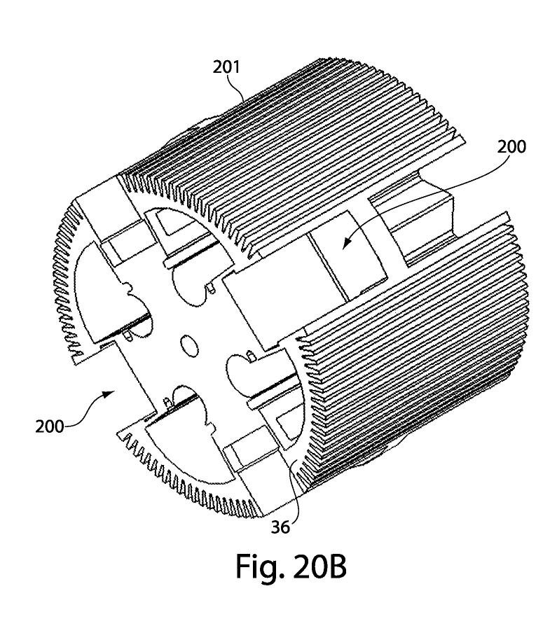

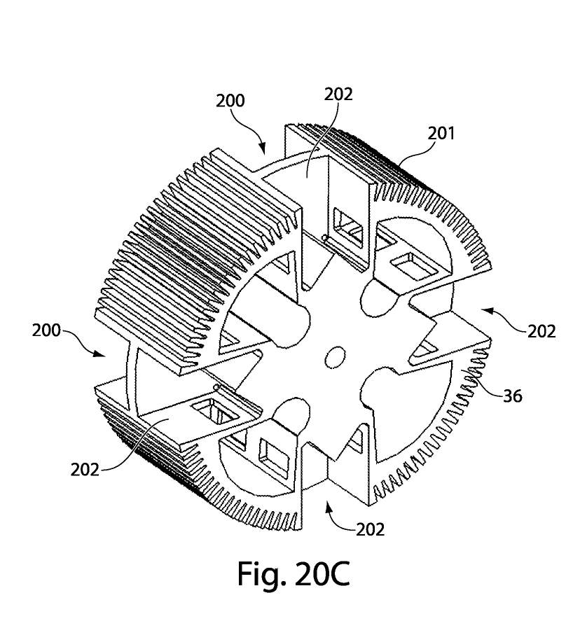

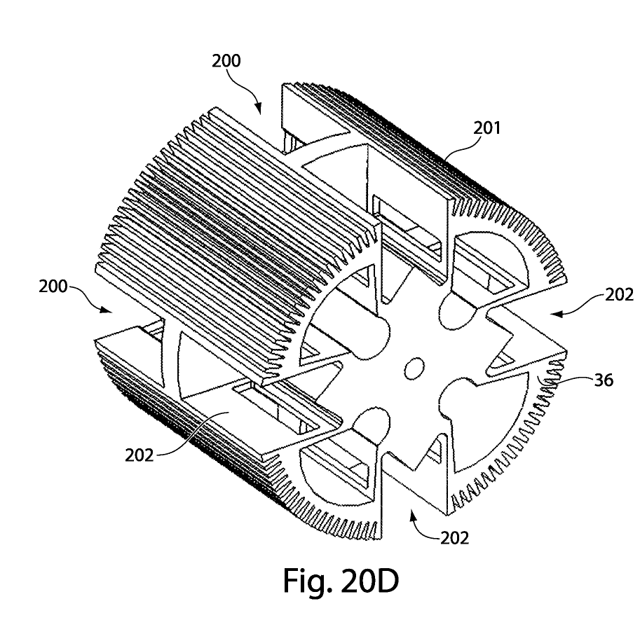

FIG. 20A shows a view of the inlet face of a machine of the present invention whereby the inlet ports are radially initiated on the outer peripheral surface of the machine. The figure illustrates four radial ports 200 whereby the fluid enters from the outer radial surface 201 of the stator 36.

FIG. 20B shows the extensible nature of this type of porting in a longer machine. FIG. 20C shows a similar view of the discharge side of the machine whereby the discharge ports are radially terminated on the outer peripheral surface of the machine.

The advantage of such an arrangement is that when the machine is extended in length, with an according increase in chamber volume, the ports of FIGS. 20A and C are also extended to provide sufficient area for the effective flow of fluid into the enlarged chamber volumes. This is shown in FIGS. 20B and 20D, inlet side and discharge side respectively.

FIG. 20C illustrates four radial discharge ports 202 whereby the fluid exits from the chambers of the machine to the radial ports in the stator. FIG. 20D shows the extensible nature of this type of discharge porting in a longer machine.

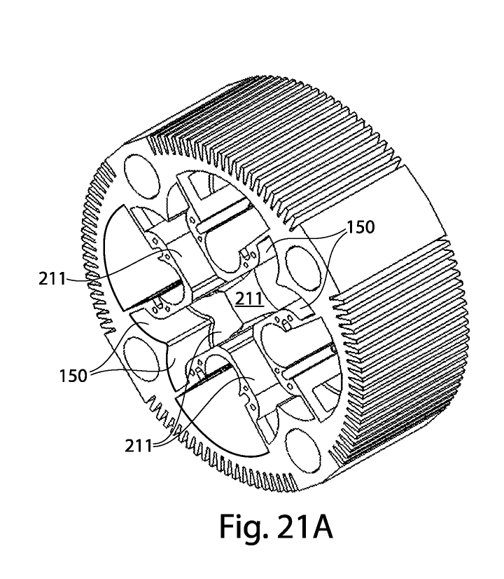

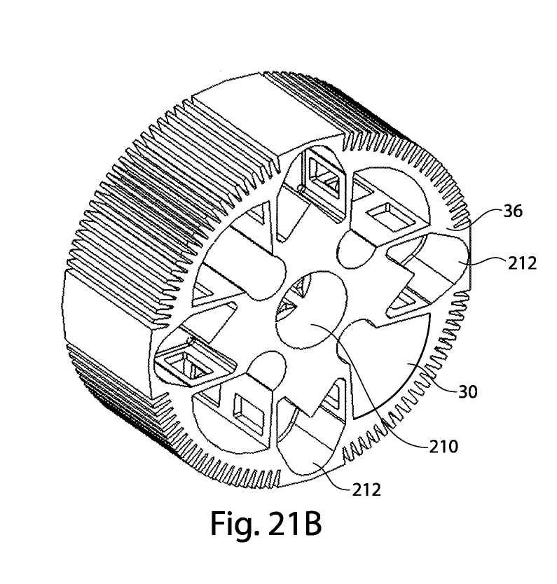

In applications where there is severely restricted radial space available, the machine can also be ported on its axial faces. FIG. 21A shows the inlet face of another embodiment of the machine of the present invention whereby the inlet ports are initiated on the inlet face. FIG. 21B shows the discharge face of the machine of FIG. 21A with the discharge ports being terminated on the discharge face. The ports in this embodiment are axially located as opposed to radially located as in the previous embodiment.

Axial porting as depicted in FIG. 21A-B shows the central axial inlet port 210 (shown in FIG. 21B from the discharge side of the stator) which splits into four pillars 211 which then each bifurcate to form two inlet ports 150. FIG. 21B illustrates axial discharge porting of the oscillating vane machine of the invention. The discharge ports 212 receive fluid from the main chamber and then discharge the fluid axially.

FIG. 21B illustrates axial discharge porting of the oscillating vane machine of the invention.

According to the present invention, the cams may be configured to comprise a “dwell” (e.g., pause) at any stage during the cycle causing a pause of the action of the pivoted vanes.

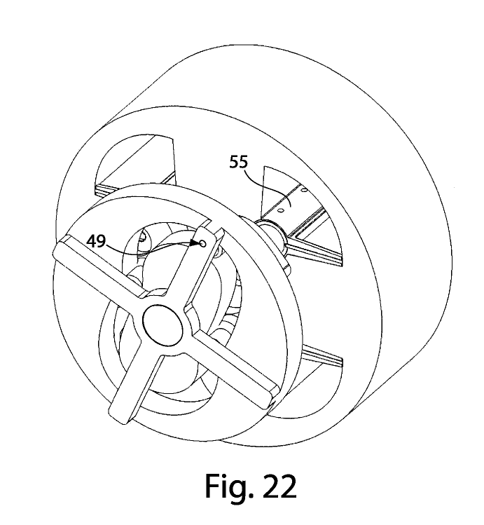

FIG. 22 illustrates an example of a cam configured with a dwell characterized by a recessed portion in the lobe or contour. This figure depicts the oscillating vane machine of the invention as in FIG. 9. The vanes oscillate through one complete cycle while the cam rotates through one-half of its cycle, thus, the cam is double acting as in FIG. 9.

In the figure, the grooved bi-lobed cam actuates four pins. This configuration is especially effective at high speeds in order to transmit sufficient power to the pivoted vanes. In this embodiment the geared pinions have been replaced with lever arms.

Furthermore, in the absence of any gas pressure for stabilization, at high speeds, inertia presents a problem. However, when pressurized, the gas pressure in the machine decreases the load on the machine.

Cams of the present invention may have one or more dwells and the dwells may be symmetric or asymmetric. Incorporation of dwells allows the machine of the invention to perform operations at constant volume. This is especially advantageous with expanders.

It is also known that heat addition to a system is most efficient when the heat is added at constant volume. Utilization of a cam dwell in the present invention allows for exploitation of power cycles which operate at least in part at constant volume such as those described in U.S. Patent Application 60/860,163, (Attorney Docket Number 4004.3022 US) filed Nov. 20, 2006, entitled Systems and methods for producing power using positive displacement devices the contents of which are incorporated herein by reference in their entirety.

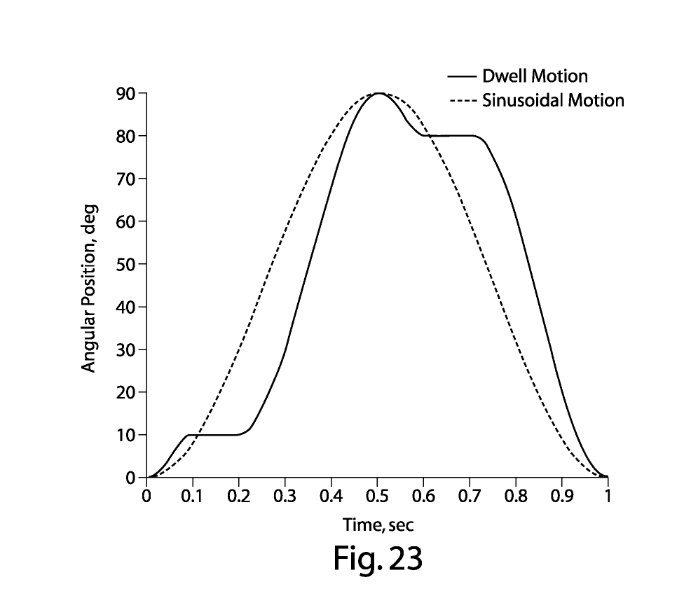

FIG. 23 (a graph of Angular Position vs. Time for a single oscillation of a vane) illustrates the acceleration and deceleration profiles of an oscillating pivoted vane configured in the oscillating vane machine of the present invention having a dwell-containing cam. The figure illustrates multiple dwells and plateaus and shows the difference in the vane motion between pure sinusoidal motion and motion with dwell. The vane position starts at 0 degrees, travels to 90 degrees, and then returns back to 0 degrees. The dotted line shows the vane position using sinusoidal motion. The solid line shows the vane position when a dwell is inserted. The vane starts at 0 degrees and travels to 10 degrees where it dwells at that position for 10% of the cycle, then it travels to 90 degrees, changes direction, returns to 80 degrees where it dwells for another 10% of the cycle, after which it moves back to 0 degrees. The absolute measure of time is not critical because if the machine is operating at a slower or faster speed then the amount of time per event will be larger or smaller. Hence the motion is normalized to 1 second to show a possible proportion of time at dwell versus time for the overall event. In the figure, the dwell was chosen to occur arbitrarily at 10 and 80 degrees. In practice, the dwell location and duration are determined by the application and may occur at any values between 0 and 90 degrees.

In one embodiment, the driving mechanism may comprise a grooved multi-lobed cam lacking gears which actuates multiple pins independently and simultaneously and whereby one revolution of the cam produces one or more complete sinusoidal oscillations of each of the four pivoted vanes. The oscillating vane machine ports can be located in any number of positions.

The valves of the oscillating vane machine of the present invention may be in fluid communication with the atmosphere, each other or other devices.

According to the present invention, all rubbing or contacting surfaces between the pivoted vanes and the housing, stator or main chambers, are designed to ensure minimal frictional losses. As such, materials used for manufacturing the machine and for surface coatings or treatments should be carefully matched. Optimization of sealing conditions and selection of sealing materials or lubricants is within the skill of the art. Furthermore, when the relevant housing or stator components and the vane are made from low expansion, low friction materials, such as ceramics, it may be practicable to dispense with lubrication altogether.

According to the present invention, seals are formed between the pivoted vanes and the lateral and distal surfaces of the chambers. In addition, the pivots of each vane form a conformal seal with the stator or housing.

In one embodiment the pivoted vanes are configured with balanced seals. Balanced seals allow for higher operational speeds without the manifestation of a deforming centrifugal force resulting on the distal vane surface 13 or the lateral vane surface 14 as is seen with sliding vane machines of the art.

The seals used may comprise any sealing material including composites, plastics, rubber, Teflon, and the like.

The oscillating vane machine of the present invention is useful as a compressor. As such, the compression achieved by the machine may be substantial in any leading chamber, and even more when multi-staged.

In another embodiment, the oscillating vane machine of the present invention operates as an expander. As such, inlet ports act to allow sufficient compressed fluid to enter the chamber then allow the compressed fluid to drive the vanes, extracting work until final exhaust at a pressure equivalent to that desired at the discharge port.

When the application of the invention requires the compressor to remain in constant operation, capacity control devices become necessary. Therefore, in one embodiment, the oscillating vane machine of the present invention comprises a capacity control device. These devices act to re-route or bypass the normal compression process and thereby minimize the electricity used by the compressor when demands for compressed gas are low. Capacity control devices include, but are not limited to, a valve, a bypass circuit, a throttle plate and any combination thereof.

Employing flow bypass in the oscillating vane machine of the present invention it is possible to achieve at least five levels of output (0%, 25%, 50%, 75% and 100%) running at a constant speed. This is possible due to the design of the four pillars and their bifurcation into dual ports which feed into the four main chambers.

For example, at 0% flow it must be true that either a) no fluid or gas enters, b) any fluid or gas that does enter isn't pressurized and is sent back out to the atmosphere, or c) all of the fluid or gas entering and that isn't pressurized is recirculated within the system.

To selectively control the capacity of the machine of the invention, a bypass strategy is selected whereby one or more pillars is shut off (i.e., discharged fluid or gas is ported back into the inlet valve and recirculated within that pillar). To achieve the recirculation, is simply a matter of placing a valve between the discharge port and the inlet port.

Depending on the number of pillars shut off, capacity and therefore output can be controlled yet still allow the machine to run at a constant speed. Shutting off one pillar results in a 25% reduction in capacity, while two pillars results in a 50% reduction, three in a 75% reduction and four totally eliminating output with all flow being recirculated.

When used as a compressor, the oscillating vane machine of the present invention may also be equipped with an unloader. Unloaders are necessary to reduce the wear on the machine during high amperage drawing events such as on initial startup. When at speed the unloader may then become the loader. When unloading, it is not desirable to have any pressure buildup in the machine. To counter this, bypass of all four pillars as referred to above, is triggered. When the machine is up to speed however the amperage will go down and then it becomes possible to introduce more load in the form of gas compression. To implement this loading, the bypasses triggered earlier need only be switched off or reversed.

Multi-staging of the machine of the invention can be accomplished in much the same way as the bypass described above. Multi-staging may occur in 2, 3 or 4 stages and may further comprise an intercooler. During multi-staging in a four chamber machine, not all of the chambers need be at the same pressure. For example three main chambers may be ported and valved to compress the fluid or gas which is then ported to the fourth chamber. Optionally an intercooler may be inserted between the first three chambers (stage 1) and the fourth chamber (stage 2).

In this way, multistaging increases the efficiency of the machine as it reduces the electricity necessary to compress the fluid or gas as long as an intercooler or other means of rejecting heat between stages is utilized.

The present invention is also amenable to applications of variable pressure ratio multi-staging. In this application, the chambers can be dynamically reassigned to improve performance particularly at high pressure ratios like those used in storage compressor facilities.

It may also be necessary to incorporate a cooling system into the oscillating vane machine of the present invention. Coolants useful in such as system include water, oil, a refrigerant or the like. Additionally, the coolant may act as a lubricant.

There are many properties of the present invention that may be optimized or altered to improve the performance of the machine at high speed. For example, in the automotives industry, reduced weight, increased power density at low cost is critical.

The present invention solves all three of these problems.

(1) Weight—As a substantial portion of the oscillating vane machine of the present invention comprises the open space of the chambers, the overall weight of the machine is less.

(2) Power density—In order to produce a high power density machine, it is necessary to eliminate bending moment and optimize porting and maximize fluid flow. As described herein, the present invention solves all three problems.

(3) Cost—As less material and articulating members are necessary in the machine of the invention, coupled with the simplicity of the design, cost of manufacture of the oscillating vane machine of the invention will be less than conventional compressors and expanders.

The present invention has applications in power supply configurations (either functioning as a compressor or expander) which exploit natural resources such as solar, geothermal, wind power.

The present invention finds uses as either a compressor or expander or in some instances where multiple machines are used in a single application, as both. The present invention may operate to expand or compress any number of working fluids. As used herein the term “working fluid” includes any substance acting as a fluid as that term is used in the art. Working fluids may comprise air, water (including all phases of water), multiphase hydrocarbons, fuels, flowable gases, compressible gases, mixtures and the like.

In these uses it is expected that the market entry device could take many forms. These include, but are not limited to single compressor or expander systems as well as multi-component arrays. The power rating on these systems may vary and includes systems having a capacity of 1-5 MW, 5-10 MW, 10-50 MW, 10-20 kW, 20-40MW, 5-10kW, 20-50 kW, 50-100kW, 500-100 kW or 100-500 kW.

The present invention has many applications. Broadly, the present invention may also be used in compression, power generation, as well as power recovery. The present invention finds use in many commercial process applications, including in the automotive industry, refrigeration, applications and the like detailed herein.

It will be understood that applications recited herein are not exhaustive and not meant to be limited solely as categorized. As such, any one or more uses of the present invention, as either a compressor or expander, as single or multi-stage, may be combined to address the particular problem.

Power Generation

When used as a compressor, the invention may derive motive power or force from many sources including natural and artificial inputs. Natural motive forces include, but are not limited to wind, wave, ocean and river current, solar and geothermal. Artificial motive forces or those which are man-made or deriving from man-made technology include, but are not limited to heat engines and electrical motors.

The compressed fluid may be expanded immediately for the generation of power or other useful products, or may be stored for later expansion.

When used as an expander the invention may derive motive power or force from compressed and/or heated fluids, translating such force of pressure into mechanical or electrical power. The invention may also expand such compressed fluids directly into useful products such as isolated gases or liquefied air.

Wind

In one embodiment, the present invention is useful in wind-driven applications. As used herein, the term “wind-driven applications” include those applications or uses of the present invention as either a compressor or expander or both in a process, device or method which captures, harnesses or otherwise exploits wind, wind power or wind energy.

As a motive force, wind can be harnessed, in conjunction with the present invention in improvements in compression and storage of compressed gas, as well as in the compression of gasses or fluids for storage and electricity generation.

In one embodiment, the motive force of the wind may be exploited using the present invention in technologies involving mechanical vapor recompression (MVR).

In one embodiment, the present invention employing wind as a motive force may act as a compressor to produce liquid air or liquid air products, and compress carbon dioxide for sequestration.

Wave

As a motive force, waves can be harnessed, in conjunction with the present invention in improvements in compression and storage of compressed gas, as well as in the compression of gasses or fluids for storage and electricity generation. In one embodiment, the motive force of waves may be exploited using the present invention in technologies involving mechanical vapor recompression (MVR).

In one embodiment, the present invention may be used in offshore applications.

In one embodiment, the present invention employing wave as a motive force may act as a compressor to produce liquid air or liquid air products, and compress carbon dioxide for sequestration.

Ocean Current

Further, the present invention may be integrated into ocean or river current technology for electricity generation as well as for offshore maritime or marine applications for power or electricity generation.

Distributed CAES

Further, the present invention may also be harnessed or exploited in the use of distributed Compressed Air Energy Storage (CAES) systems. This application also finds uses in electricity generation and storage. In one embodiment, the generation and/or storage may be at the customer side or end of the meter.

Power Recovery

When used as an expander, the present invention may be powered by any number of heat sources, natural or artificial. For example, when a process or method employs the use of steam or vapor, the heat necessary to generate the steam or vapor may come from any number or sources. Heat sources include, but are not limited to solar, geothermal, radioactive (nuclear) and chemical. Also included are exhausts from other processes and the combustion of fuel, including waste heat and intentional heat.

In many processes of energy production, much energy is lost to the system and surroundings as heat. Waste heat recovery therefore represents an attractive avenue for improving and optimizing any heat-generating system. For example, engines represent a major class of prime movers in society. These prime movers generate a great deal of waste heat that, if captured and exploited, could reduce the overall cost of systems using them. Waste heat recovery may also be effected from incineration, anaerobic digestion, composting, radioactive, mechanical biological treatments, recycling plants and processes, sewerage, biogas recovery, landfill gas recovery, biomass gasification. Industrial processes which could benefit from incorporation of the machine of the present invention include, for example, aluminum smelting, metal casting, steel processing, glass making and chemical processing including manufacture or processing of fertilizers or in the production or refining of hydrocarbon fuels including gasoline.

To this end, the present invention may be used to capture waste heat from engines in many processes.

Applications of the present invention include, bottoming cycle expanders for power recovery from waste heat of diesel/gas powered engines including microturbines, backpressure steam expanders for power recovery from district heating/distributed steam pressure reduction), boiler cogeneration expanders and micro cogeneration expanders for recovery of power from waste heat, and as chiller expanders for the recovery of power from expansion of refrigerant. In all these cases the recovered mechanical power may be used directly or to drive a generator to produce electricity.

As used herein a “GenSet” is any distributed generator system or electrical generator such as a diesel, natural gas, or gasoline powered generator located in proximity to the end-user rather than in a central location such as those utilized by commercial power providers. A genset can be utilized as an augmentation to an existing electrical grid system or as an “off-grid” power source depending upon the needs of the user. Gensets are often used by hospitals and other industries which rely upon a steady source of power, as well as in rural areas where there is no access to commercially generated (‘grid’) electricity.

The present invention may also be used in conjunction with gas pipelines for electricity generation (e.g., power recovery from reduction of transmission to distribution pressure) and in microturbine combined cycles (e.g., power recovery from waste heat of microturbine fuel combustion).

Process Applications

The present invention also finds utility in several processes including, but not limited to process compression and process expansion of working fluids.

In one embodiment the present invention may be used in air compression applications such as in pneumatics for tools or machinery. In some embodiments the compressor may be coolant injected or water injected.

In one embodiment the present invention may be used in natural gas compression, gas field/wellhead compression into collection system or compression to transmission pipeline pressure.

As an expander the present invention may be employed in natural gas regasification and for removal of contaminants from natural gas.

Process Compression

Within the field of process compression the present invention may be exploited in chemical processes such as separation processes including air and constituent gas separation. These processes may include the separation of hydrocarbon gases and related gas separations as well as petrochemical refining. In these processes a compressed gas is cooled causing constituents such as long chain hydrocarbons (greater than 3 carbons) to drop out of the mixture. It is also possible to recover power from this expansion process.

In one embodiment steam or vapor upgrade or evaporation enhancement can be accomplished using the compressor of the present invention. For example, a compression cycle may be used to create steam or vapor at a higher pressure from steam at a lower pressure instead of making the higher pressure steam from ambient working fluids.

In one embodiment, the present invention can be used in the food processing industry.

Refrigeration/HVA C/Air Cycles

The present invention may be employed in any number of compression or expansion processes within devices involving air cycles. In this manner, the present invention may be used for compressing refrigerants in heat pumps, chillers and in refrigeration cycles. It may also be used for compressing refrigerants that are condensing as well as gas cycle refrigerants. In addition to conventional refrigerants the compressor may employ as a working fluid natural refrigerants such as carbon dioxide (CO₂), air and ammonia.

Devices which may be configured or manufactured to utilize the present invention include, but are not limited to, air separation units (ASUs), air conditioning systems, packaged condensing units (e.g., air conditioning units located on the roofs of commercial buildings) and splits (e.g., medium sized air conditioners). In one embodiment the present invention may be used in integrated chillers/refrigeration units (window air conditioners) or in stand-alone air conditioners. The devices may be further intercooled. Technological application of cryogenics may also utilize the present invention.

Distillation/MVR (Mechanical Vapor Recompression)

In one embodiment, the present invention may be applied in the field of distillation or mechanical vapor recompression (including for distillation). Irrespective of motive force, the machine of the present invention may be used to facilitate these processes.

To this end, the present invention may be used in the process of petroleum processing, distillation of ethanol or other alcohols or alcohol-containing liquids, water purification and constituent or waste separation/concentration.

CO₂ Compression/Sequestration

The present invention may be used in the separation/sequestration of CO₂ as, for example, in the process of enhancing oil recovery. It may also be used in the compression of gases originating from flue gas separations or flue gas processes.

Automotive

The machine of the present invention may be used in many aspects of the automotive industry. As used herein “automotive” embraces on-road and off-road vehicles including military, construction, mining and farm vehicles. Also included are aircraft and marine vehicles and applications therein.

To this end, the present invention may be used as an automotive supercharger, or as the compressor or heat pump in an automotive air conditioning system, It may also be integrated into automotive exhaust systems (potentially replacing conventional blowers) or used for air braking. It may also be for bottoming cycle power (waste heat) recovery as an alternative to turbo-compounding. Further, the present invention may be used in hybrid air accumulation (supercharger) such as those in hybrid vehicles.

Other Applications

In addition, the present invention may be used in fuel cells, vacuum pumps, liquid pumps, heat pumps and for any application requiring a compressor or expander in solar heat power generation.

Incorporation into Compressed Air Energy Storage (CAES) Systems and Devices

The present invention may also be used by electricity consumers to relieve them of high charges for energy and power demand from load serving entities (LSE) with use of compressed air energy storage (CAES) systems that do not need but may use combustion to provide power for peak use on the customer side of the meter, creating a new method of doing business that makes development of CAES systems that are economically viable.

Our invention focuses on using a CAES system on the customer side of the meter without combustion and integrated into the energy management program (EMP) of the facility, so that end users can reduce their costs. The system can be run manually or connected into a building Energy Management System (EMS) that manages the extraction of energy from the CAES system to reduce costs. It can be remotely monitored by associates of the end user (headquarter, consultants, suppliers or renters of the CAES system) to assure performance and reduction in energy costs. The system should preferably comprise panels equipped with switchgear that would allow power to flow from the grid into the end user's facilities, from the CAES system into the end user's facilities, and, optionally, from the CAES system to the grid. Power extracted from the CAES system during periods of peak use or high rates will enable the end user to reduce the power purchased from the grid, with a reduction in the kW or demand charge during the period of peak uses or higher rates.

The voltage from the CAES system would most likely be the same voltage as the end user needs, so that if the power is sold back to the grid it would go through the transformers, if any, before entering the grid.

The system can also be integrated with equipment that captures and uses the cooling capacity of the CAES system that develops when the compressed air is expanded.

In one embodiment the CAES system is built on the customer side of the meter (i.e., “on-site”). This system consists of an OVM compressor that compresses a fluid, such as air, into storage container that is, optionally, buried in the ground. The container is capable of withstanding high pressures. An OVM expander expands the compressed air when power is needed, usually during the period of peak power demand as indicated on the clock. The OVM compressor and expander could be the same device or separate devices. The OVM compressor is operably linked to at least one power source, such as utility supplied electricity sourced from the utility side of the meter. Alternatively, the power source can be a solar panel. In a particularly preferred embodiment, the power source is not a combustion engine. The OVM expander converts the energy stored as compressed air into mechanical power. This mechanical power may be used directly or to drive a generator, which converts the mechanical power into electricity. Power is then provided to the customer's facilities, using a generator that is part of the designed system to do so, preferably using low voltage suitable for the host facility. Cooling can also be extracted from the expanding air stream and cools water in the water stream via heat exchanger. The water is either used immediately for cooling or is stored for later use. This displaces the demand for power for air conditioning, especially at peak temperatures and demand.

While a single storage container, compressor and expander can be used, a plurality of storage tanks, compressors, and/or expanders may be used in order to assure redundancy, reliability, availability and to avoid demand charges for equipment failure.

The storage containers can be accessed in series or in parallel, can be the same or different sizes. The containers can optionally be insulated to reduce heat loss or not insulated to facilitate heat loss.

The compressed fluid (e.g., air) can be stored in an underground void (such as a cave or mine), although it will often be preferable to store in a tank above or preferably below ground. In one embodiment, the tank is mobile (e.g., a truck). The container is preferably designed to withstand a variety of possible pressures. The size of the container and the pressures that it is designed to withstand are related to the energy capacity of the system. Where size of the container is a limiting design factor, the container can be designed to withstand 100 atmospheres or more.

The storage container and, optionally, other components of the on-site CAES systems could be buried deep enough to be attack-proof or resistant.

Use in Supercharging or Turbocharging Applications

The invention relates to a supercharger and turbocharger for an internal combustion engine. In a preferred embodiment, the invention comprises an internal combustion engine comprising a combustor (such as one or more cylinders, each cylinder providing a combustion chamber and one or more fuel injectors in communication with said cylinder(s), capable of injecting fuel into each said combustion chamber); an air intake line operatively connected to the cylinder(s) and to an OVM compressor, to provide compressed air to the combustion chamber(s) from the compressor; an exhaust line also operatively connected to the cylinder(s), to receive exhaust gas from the combustion chamber(s); and a main crank shaft functionally attached to and driven by said cylinder(s).

Air is provided to the OVM compressor via an intake line. The air can be fresh air or re-circulated air, as can be provided from crankcase gas or exhaust, or some combination thereof. Further, the air can be provided at atmospheric pressure or compressed (e.g. via an OVMC) and at ambient temperature, heated (as can occur upon compression) or cooled (e.g., via a heat exchanger or regenerator). The system of the invention can further comprise, in addition or as an alternative to the OVM compressor, an OVM expander operatively connected to exhaust line.

In a particularly preferred embodiment, at least a portion of the exhaust gas from the combuster is directly or indirectly (e.g., via the expander) directed to the air intake line of the system. This can be accomplished by, for example, directing a recirculation line of a portion of said exhaust gas to said air intake line. An EGR control valve operated so as to control the concentration of re-circulated exhaust gas and air can be advantageously added. Typically, between 10 and 30% of the total intake gas directed into the OVM compressor is recirculated exhaust gas.

In yet another embodiment, exhaust gas can be direct to the OVM compressor prior to mixing with the intake air via line. In this embodiment, one or more chambers of the OVM can be dedicated to compressing exhaust gas independently of compressing air. The compressed exhaust gas and air can be subsequently mixed for combustion. Thus, by way of example, two or three chambers can compress exhaust while six or more compressors can compress air. This embodiment provides an alternative method for controlling recirculation.

The system can include a controller (e.g., a computer) that controls at least one of: the quantity of fuel injected, the quantity of recirculated exhaust gas, the quantity of air, the pressure of recirculated exhaust gas, and/or the pressure of air.

In yet another embodiment, crankcase gas can be removed from the combustor and recirculated via the intake air line. This gas can be advantageously pumped via an OVMC, as described herein. Combinations of multiple OVMs providing a single device that manages multiple (or all) gas flow within the engine or system are possible.

Alternatively embodiments of the invention include by-pass valves that permit avoiding supercharging the intake gas when it is unnecessary.

Small or Miniaturized Devices

It is an object of this invention to provide a low pressure, high air flow compressor or air blower for use in electronics and similar applications. In a preferred embodiment, the compressor is an OVM compressor. The OVM compressor of the invention is a low-pressure compressor. Air pressures typically provided for the purposes of cooling electronic components are typically very low, in the range from about 0.005 to about 0.01 atm. In one embodiment, the low-pressure OVM compressor can provide pressurized air at pressure of greater than 100 mm of water.

Current expected air requirements for different computer applications include an air flow between about 3-6 l/min at about 0.01-0.015 atm for a mobile personal computer; between about 5-10 l/min at about 0.015-0.03 atm for a desktop personal computer; and between about 10-20 l/min at about 0.025-0.05 atm for a performance computer. The compressor of the invention is preferably a high flow compressor. The air flow achieved by the compressor can be up to or exceed 20 liters per minute and can be up to about 300 hundred liters per minute, or more.

The compressor is configured to provide air to a heat exchanger for the purpose of cooling electronic components. In an alternative embodiment, the compressor is configured as a vacuum pump to remove air from a heat exchanger for the purposes of cooling electronic components.

Electronic systems incorporating the invention include a variety of computer systems (such as servers, personal computers, notebooks, and the like) other than the embodiment illustrated herein, and moreover to electronic and electrical devices other than computer systems, including, but not limited to, power supply, plasma TV, automotive electronics, airborne electronics, and the like. The electronic components that can be cooled according to the invention include heat generating components, including, processors, micro-controllers, high speed video cards, disk drives, semi-conductor devices and the like.

The compressor is sized to permit insertion into the electronic system housing. Thus, the compressor can be miniaturized to a size of about a liter for larger electronic systems or less than about 8 cm³, in the case of a notebook. In the case of a notebook, the compressor should be constructed from light weight materials.

The compressor is configured to provide a gas, such as air, to an electronic system or its components for cooling purposes. Thus, the compressor can provide air by blowing air (e.g., a blower) into the system or by drawing air (e.g., a vacuum pump) from the system. The gas can be any gas or coolant. However, an advantage of the present compressor that it does not need to employ special coolants and can use air, e.g., ambient air. While in some instances, the gas is the only coolant or material used for cooling. However, it can often be desirable or advantageous to employ a heat exchanger, regenerator and/or heat sink to further dissipate and control manage the heat in the system. In one embodiment, the compressor is operated in conjunction with an expander and heat exchanger. In this embodiment, the heat of compression is rejected, and expansion allows an air of the temperature lower than ambient to be directed at the components to be cooled.

In yet another embodiment, the heat exchanger itself is the expansion device, operating either where the compressor and a means of heat rejection providing pressurized air to the expansion device/heat exchanger, or where the compressor is operating as a pump, and the pressure dropped is occurring upstream of the pump in the heat exchanger expansion device.

The compressor can be configured to include one or more of the other thermal management components.

Offshore, Wave and Ocean Energy Exploitation

The present invention may be used as a component of one or an array of buoys that are connected to form a wave energy extraction system. The OVMs of the present invention may be employed in a manner to act as either a compressor or expander for use in the extraction of energy from heave and surge and subsequent transmission, storage, and conversion to electricity.

Optimization of Energy Cycles

In one embodiment, the compressed air may act as a working fluid within a non-combustion power cycle such as those disclosed in copending patent application Ser. No. 60/60/860,163 by Ingersoll, Attorney Docket Number 4004.3022US filed Nov. 20, 2006, the contents of which are incorporated herein in their entirety.

Wind Power Exploitation for Power Generation Capture and Recovery

It is an object of this invention to provide a fluid compressor comprising: a wind turbine (including, but not limited to a Horizontal Axis Wind Turbine or a Vertical Axis Wind Turbine, or Arrays or Clusters grouped together in multiples of said wind turbines); an oscillating vane machine compressor (OVMC) characterized by a fluid intake opening and a fluid exhaust opening, wherein the wind turbine drives the OVM compressor. The combination of the OVMC and wind turbine along with facility for storage of the compressed fluid permits excellent control over the time of electrical power generation, thereby maximizing the commercial opportunity and meeting the public need during hours of high usage. Additionally, the invention in certain embodiments avoids the need to place an electrical generator off-shore. Additionally, the invention allows for the production of other products than electricity, such as mechanical power when desired. Further, the apparatuses of the invention can be operated with good to excellent efficiency rates.

In one embodiment, the invention comprises a generator apparatus comprising:

(a) a wind turbine;

(b) at least one OVM compressor characterized by a fluid intake opening and a fluid exhaust opening, wherein the rotation of the turbine drives the OVM compressor;

(c) a conduit having a proximal end and a distal end wherein said proximal end is attached to said fluid exhaust opening;

(d) at least one oscillating vane machine expander (OVME) characterized by a fluid intake opening attached to said distal end;

(e) an electrical generator operably attached to said OVM expander to convert mechanical power to electricity.

The wind turbine is powered by air flow such as is created by wind. In this embodiment, the turbine can be a windmill, such as those well known in the art. One example of a windmill is found in U.S. Pat. No. 6,270,308, which is incorporated herein by reference. Because wind velocities are particularly reliable off shore, the windmill can be configured to stand or float off shore, as is known in the art.

The invention further relates to the use of an OVM to store and release energy in the form of a compressed gas or fluid, such as air. In such an embodiment, the turbine can be replaced with another power source that drives the OVM.

Further, the sizes, capacities, of the OVMCs and OVMEs can be approximately the same or different. Additional modifications to further improve energy usage can be envisioned from the apparatus of the invention. Energy recycle streams and strategies can be easily incorporated into the apparatus. For example, the expanded fluid exiting from the expander will, in the absence of heat addition, generally be cold. This fluid can be efficiently used as a coolant, such as in a heat exchanger to provide refrigeration, air-conditioning, coolant for a condensing process. Likewise, the compressed fluid exiting from the compressor, or the cooling liquid, such as from the intercoolers, may be used to provide useful heat to a process.

The OVM compressor and OVM expander can be controlled to control the temperature or energy level of the fluids or gases, such as by controlling the rate, pressure, etc. Alternatively multiple sources of fluid (e.g., at different temperatures) can be used to control the temperature of the fluid at various stages of the process. The process can also be controlled by varying the pressure ratio of the compressor and/or expander to allow for optimal injection pressure into the receiver in relation to the pressure of the stored air.

In one embodiment, the apparatus comprises one, two or more oscillating vane machine (OVM) compressors. The compressors can be configured in series or in parallel and/or can each be single stage or multistage compressors. The OVM compressor will generally compress air, however, other environments or applications may allow other compressible fluids to be used. Examples of other compressible fluids include hydrogen, biogas, methane, natural gas (as may be found in a gas pipeline), propane, nitrogen, ethanol, carbon monoxide, carbon dioxide, argon, helium, oxygen, fluorocarbons, acetylene, nitrous oxide, neon, krypton, xenon, and the like.

The turbine is generally configured to power the OVM compressor(s). For example, the turbine can drive the OVM compressor by a friction wheel drive which is frictionally connected to the turbine and is connected by a belt, a chain, or directly to a draft shaft or gear of the compressor, or through a hydraulic drive.

Additionally, the invention can provide a method or means of controlling or allowing a turbine to drive the generator, the OVM compressor, or both (e.g., simultaneously). In a typical prior art apparatus, the variability of the torque of the turbine is undesirable. Where the turbine is driving the generator and OVM compressor, simultaneously, the apparatus can be configured and controlled to ensure that the torque to the generator is constant or fixed and the flux is controlled or modulated by the OVM compressor. Thus, variable flow can be used to modulate torque of the turbine allowing the generator output to be more constant.

Additionally or alternatively, the invention may include a means or method of control enabling a turbine and/or the OVM expander to drive the generator and/or OVM compressor. In this embodiment, the expander can complement the power input of the turbine.

In yet another embodiment, the generator (or other external power source) can drive the OVM compressor. This can be desirable to replenish the power storage within the conduit using off-peak power for use during peak power times, even when the turbine's activity is insufficient to do so.

In another embodiment, the oscillating vane machine compressor/expander (OVMC/E) can also be configured so that it can function as a compressor during the storage phase of the cycle and an expander during the power production phase.

The air exiting the compressor through the compressor exhaust opening will directly or indirectly fill a conduit. Multiple turbines, and their associated compressors, can fill the same or different conduits. For example, a single conduit can receive the compressed air from an entire windmill farm, wind plant or wind power facility. Alternatively or additionally, the “windmill farm” or, the turbines therein, can fill multiple conduits. The conduit(s) can be used to collect, store, and/or transmit the compressed fluid, or air. Depending upon the volume of the conduit, large volumes of compressed air can be stored and transmitted. The conduit can direct the air flow to a storage vessel or tank or directly to the expander. The conduit is preferably made of a material that can withstand high pressures, such as those generated by the compressors. Further, the conduit should be manufactured out of a material appropriate to withstand the environmental stresses. For example, where the windmill is located off shore, the conduit should be made of a material that will withstand seawater, such as pipelines that are used in the natural gas industry.

The location of the conduit can be under the ground or ocean surface or on the surface of the ground or an integral part of the wind turbine tower (e.g., a supporting member or nacelle).

The air (fluid) feeding the OVM compressor can be cooled in a slip, or side, stream off the conduit or in a storage vessel or tank. The air (fluid) feeding the OVM expander can be heated. Heating the fluid can have the advantage of increasing the energy stored within the fluid. The compressed air can be subjected to constant volume and/or constant pressure heating. The sources of heating/cooling can include thermal energy available in the oceans, rivers, ponds, lakes, underground and shallow or deep geothermal heating (as can be found in hot springs) or in the combustion of fuels. The conduit, or compressed air, can be passed through a heat exchanger to cool waste heat, such as can be found in power plant streams and effluents and industrial process streams and effluents (e.g., liquid and gas waste streams).

In one embodiment, is a method of storing and transporting wind generated power, comprising determining a site where wind speeds are sufficient for generating wind power that is remote from a user; providing one or more wind turbine stations for generating energy located at said first site; providing at least one OVM compressor per dedicated wind turbine associated with said one or more wind turbine stations; determining a planned route between said first site and a second site to be serviced by said wind turbine stations, (which includes, among other things, determining the approximate distance between said first and second sites; providing a pipeline structure along said planned route between said first and second sites for storing compressed air energy generated by said wind turbine stations; determining the pipe size and air pressure based on the amount of storage space that is needed within said pipeline structure, taking into account the approximate distance between said first and second sites; extending said pipeline structure from said first site to said second site along said planned route); providing at least one OVM expander located at or near said second site to allow said compressed air energy to be released; and providing an electrical generator to convert said compressed air energy released by said OVM expander into electrical energy.

In this embodiment a first site may be located on a platform located in a body of water, with the pipeline structure extended down into the ground below the body of water, while the pipeline structure is extended to a second site located on land.

In one embodiment is provided a method of transporting wind generated energy, comprising determining a first site where wind speeds are sufficient for generating wind power that is remote from a user by providing one or more wind turbine stations for generating energy located a first site and providing at least one OVM compressor associated therewith; determining a planned route between said first site and a second site to be serviced by said wind turbine stations, wherein said planned route extends substantially along an existing path which comprises at least one taken from the following: an existing road, an existing easement, an existing conduit, an existing open access area, an existing abandoned pipeline; providing a pipeline along said planned route between said first and second sites for storing compressed air energy generated by said wind turbine stations and transporting the compressed air energy from said first site to said second site; providing at least one OVM expander to release said compressed air energy from the pipeline structure at or near said second site; providing an electrical generator to convert the compressed air energy released by said turbo expander into electrical energy; and providing said electrical energy to a user at said second site.

Further, in this embodiment, one OVM compressor may provided per dedicated wind turbine associated with said one or more wind turbine stations.

In one embodiment is provided a method of storing energy in the form of a cryogenic liquid comprising liquefaction of air via compression by an oscillating vane compressor of the invention followed by storage of the liquid for subsequent use. Storage can be in insulated tanks or conduits or pipes. The stored liquid may be expanded using any expander, preferably a TIVM (TIVE) or oscillating vane machine of the present invention. On expansion, the energy of expansion may be captured to do work. The compression for liquefaction may occur in multiple stages. The air to be compressed may be provided to the compressor from wind, a production facility, or waste air from another process. The advantage of this embodiment is that the compression and liquefaction occurs so that only insulators are required and not huge pressure vessels.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of extracting power from waste heat comprising:
identification of a source of waste heat in a process, incorporation of an oscillating vane machine expander to receive waste heat from said source, removal of thermal energy by the expansion of said waste heat through the oscillating vane machine expander, and conversion of said thermal energy to mechanical power.

2. The method of claim 1 further comprising conversion of said mechanical power to electricity by incorporation of an electrical generator operably attached to said oscillating vane machine expander.

3. The method of claim 1 wherein the oscillating vane machine expander comprises
(a) four pivoted vanes each comprising
(i) a vane, said vane being defined by a first side vane surface, a second side vane surface, a distal vane surface, a first lateral vane surface and a second lateral vane surface, wherein said distal vane surface defines a distal vane surface path and said first and second lateral vane surfaces define first and second lateral vane surface paths when the vane is rotated about a pivot axis, and
(ii) a pivot comprising said pivot axis;
(b) four individual main chambers each defined by
(i) a distal chamber surface which is defined by said distal vane surface path,
(ii) a first end wall chamber surface,
(iii) a second end wall chamber surface,
(iv) a first lateral chamber surface defined by said first lateral vane surface path and extending from the radius of the vane pivot to the distal chamber surface; and
(v) a second lateral chamber surface defined by said second lateral vane surface path and extending from the radius of the vane pivot to the distal chamber surface;
(c) a driver which drives all pivoted vanes in a balanced and oscillating motion;
(d) at least one inlet port in fluid communication with each individual main chamber;
(e) at least one discharge port in fluid communication with each individual main chamber; and
wherein one pivoted vane is disposed within each individual main chamber.

4. The method of claim 3 wherein the process is selected from the group consisting of incineration, anaerobic digestion, composting, radioactive, mechanical biological treatments, recycling plants and processes, sewerage, biogas recovery, landfill gas recovery and biomass gasification.

5. The method of claim 3 wherein the process is an industrial process.

6. The method of claim 5 wherein the industrial process is selected from the group consisting of aluminum smelting, metal casting, steel processing, glass making, manufacture of fertilizers, and production or refining of hydrocarbon fuels.

7. The method of claim 3 wherein the four pivoted vanes rotating about their pivots within said four individual main chambers are double-acting.

8. The method of claim 3 wherein the driver is selected from the group consisting of a rack and pinion system, a cam and camshaft, a rod and crankshaft, a desmodromic drive system, a cam with one or more springs, a cam and rod, reciprocating gears attached to the pivots, a dual cam with pins, a dual cam with gears, a tangential torquing device, and any combination thereof.

9. The method of claim 8 wherein the driver is a rack and pinion system which is balanced using a counterbalance.

10. The method of claim 3 wherein both the inlet port and discharge port comprise valves.

11. The method of claim 10 wherein the valves are selected from the group consisting of stationary, rotary, hinged, poppet, reed (or high frequency valve), flapper and any combination thereof.

12. The method of claim 3 wherein the oscillating vane machine expander further comprising an unloader.

13. The method of claim 3 wherein the oscillating vane machine expander further comprising a capacity control device.

14. The method of claim 13 wherein the capacity control device is selected from the group consisting of a valve, a bypass circuit, a throttle plate and any combination thereof.

15. The method of claim 3 wherein said four individual main chambers are multi-staged.

16. The method of claim 11 wherein the valves are actuated mechanically.

17. The method of 11 wherein actuation to open the valves is achieved as a result of differential pressure across said valves.

18. The method of claim 17 wherein the actuation to close the valves is achieved mechanically.
